(19) United States
(12) Patent Application Publication
(10) Pub. No.: US 2025/0378741 A1
(43) Pub. Date: Dec. 11, 2025

(54) ELECTRONIC GAMING SYSTEMS AND METHODS INCLUDING A SIDE BET PROGRESSIVE

(71) Applicant: Aristocrat Technologies, Inc., Las Vegas, NV (US)

(72) Inventors: Daniel Marston, Reno, NV (US); David Marsh, Charlottesville, VA (US); Eric Rasmussen, Reno, NV (US)

(21) Appl. No.: 18/799,856

(22) Filed: Aug. 9, 2024

Related U.S. Application Data
(60) Provisional application No. 63/656,962, filed on Jun. 6, 2024.

(51) Int. Cl. G07F 17/32

(52) U.S. Cl. CPC G07F 17/3267; G07F 17/3211; G07F 17/3258; G07F 17/329

(57) ABSTRACT

An electronic gaming system including a processor and a memory is described. The processor is configured to receive a first input amount for a play of an electronic game displayed in a first display area, receive a second input amount for a play of a side electronic game displayed in a second display area, select a first bingo card for the play of the electronic game, select a second bingo card for the play of the side electronic game, determine an outcome for the electronic game based upon a ball call and the first bingo card, determine an outcome for the side electronic game based upon the ball call and the second bingo card, and cause display of the outcome for the electronic game in the first display area and the outcome for the side electronic game in the second display area.

### CROSS REFERENCE TO RELATED APPLICATIONS

This application claims the benefit of priority to U.S. Provisional Application No. 63/656,962, filed Jun. 6, 2024, the contents of which are hereby incorporated by reference herein in their entirety.

### TECHNICAL FIELD

The field of disclosure relates generally to electronic gaming, and more specifically, to electronic gaming system and methods including a side bet progressive.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system including at least one memory with instructions stored thereon and at least one processor in communication with the at least one memory is described. The instructions, when executed by the at least one processor, cause the at least one processor to receive a first input amount for a play of an electronic game displayed in a first display area and receive a second input amount for a play of a side electronic game displayed in a second display area wherein the first input amount is different from the second input amount. The instructions also cause the at least one processor to select a first bingo card for the play of the electronic game and select a second bingo card for the play of the side electronic game. The instructions further cause the at least one processor to determine an outcome for the electronic game based upon a ball call and the first bingo card, determine an outcome for the side electronic game based upon the ball call and the second bingo card, and cause display of the outcome for the electronic game in the first display area and the outcome for the side electronic game in the second display area.

In another aspect, at least one non-transitory computer readable storage medium with instructions stored thereon is described. The instructions, in response to execution by at least one processor, cause the at least one processor to receive a first input amount for a play of an electronic game displayed in a first display area and receive a second input amount for a play of a side electronic game displayed in a second display area wherein the first input amount is different from the second input amount. The instructions also cause the at least one processor to select a first bingo card for the play of the electronic game, select a second bingo card for the play of the side electronic game, and determine an outcome for the electronic game based upon a ball call and the first bingo card. The instructions further cause the at least one processor to determine an outcome for the side electronic game based upon the ball call and the second bingo card and cause display of the outcome for the electronic game in the first display area and the outcome for the side electronic game in the second display area.

In another aspect, a method of electronic gaming implemented by at least one processor in communication with at least one memory is described. The method includes receiving a first input amount for a play of an electronic game displayed in a first display area and receiving a second input amount for a play of a side electronic game displayed in a second display area wherein the first input amount is different from the second input amount. The method also includes selecting a first bingo card for the play of the electronic game and selecting a second bingo card for the play of the side electronic game. The method further includes determining an outcome for the electronic game based upon a ball call and the first bingo card, determining an outcome for the side electronic game based upon the ball call and the second bingo card, and causing display of the outcome for the electronic game in the first display area and the outcome for the side electronic game in the second display area.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates an example screenshot and/or interface of an electronic game including a side bet progressive, in accordance with the present disclosure.

FIG. 5 illustrates another example screenshot and/or interface of an electronic game including a side bet progressive, in accordance with the present disclosure.

FIG. 6 illustrates another example screenshot and/or interface of an electronic game including a side bet progressive, in accordance with the present disclosure.

FIG. 7 illustrates another example screenshot and/or interface of an electronic game including a side bet progressive, in accordance with the present disclosure.

FIG. 8 illustrates another example screenshot and/or interface of an electronic game including a side bet progressive, in accordance with the present disclosure.

FIG. 9 illustrates another example screenshot and/or interface of an electronic game including a side bet progressive, in accordance with the present disclosure.

FIG. 10 illustrates another example screenshot and/or interface of an electronic game including a side bet progressive, in accordance with the present disclosure.

FIG. 11 illustrates another example screenshot and/or interface of an electronic game including a side bet progressive, in accordance with the present disclosure.

FIG. 12 illustrates another example screenshot and/or interface of an electronic game including a side bet progressive, in accordance with the present disclosure.

FIG. 13 illustrates another example screenshot and/or interface of an electronic game including a side bet progressive, in accordance with the present disclosure.

FIG. 14 illustrates another example screenshot and/or interface of an electronic game including a side bet progressive, in accordance with the present disclosure.

FIG. 15 illustrates an example system for electronic gaming including metering for a side bet progressive, in accordance with the present disclosure.

FIG. 16 illustrates an example screenshot and/or interface of a help page menu for an electronic game including a side bet progressive, in accordance with the present disclosure.

FIG. 17 illustrates an example screenshot and/or interface of game rules for an electronic game including a side bet progressive, in accordance with the present disclosure.

FIG. 18 illustrates another example screenshot and/or interface of game rules for an electronic game including a side bet progressive, in accordance with the present disclosure.

FIG. 19 illustrates another example screenshot and/or interface of game rules for an electronic game including a side bet progressive, in accordance with the present disclosure.

FIG. 20 illustrates another example screenshot and/or interface of game rules for an electronic game including a side bet progressive, in accordance with the present disclosure.

FIG. 21 illustrates an example screenshot and/or interface of an example paytable for an electronic game including a side bet progressive, in accordance with the present disclosure.

FIG. 22 illustrates an example screenshot and/or interface of a paytable menu for an electronic game including a side bet progressive, in accordance with the present disclosure.

FIG. 23 illustrates an example screenshot and/or interface of an example paytable for an electronic game including a side bet progressive, in accordance with the present disclosure.

FIG. 24 illustrates another example screenshot and/or interface of an example paytable for an electronic game including a side bet progressive, in accordance with the present disclosure.

FIG. 25 illustrates a diagram of example content display layers for an electronic game including a side bet progressive, in accordance with the present disclosure.

FIG. 26 illustrates an example method of electronic gaming including a side bet progressive, in accordance with the present disclosure.

FIG. 27 illustrates an example method of electronic gaming including metering for a side bet progressive, in accordance with the present disclosure.

FIG. 28 illustrates an example method of electronic gaming including dynamically generated help pages, in accordance with the present disclosure.

### DETAILED DESCRIPTION

Described herein are electronic gaming systems and methods including a side bet game and progressive (e.g., in Class II games such as bingo games and/or a Class III style game). For example, a side bet game (e.g., eligible for a cross-game progressive feature) may be an additional game that is added to a base game upon player opt in. To opt in, the player may select one of four options for a side game that is eligible to win a progressive and a bet amount (also known as a credit input) for the side game (e.g., separately from a bet or credit input for the base game). This side bet offers players an opportunity to place an additional wager which can vary from the base game wager. In other words, the side bet game can be played at wager amounts that are less than, greater than, or equal to the base game's denomination and/or the wager placed on the base game. Thus, the same game (e.g., including the base game and the side bet game) can be played at two different denominations and/or wager amounts (e.g., one for the base game and one for the side bet game).

The base game and the side bet game may be displayed in different display areas, each including a respective bet and respective win meter, so the player is aware of the amounts that are being wagered for each of the base game and the side bet game.

In an example embodiment, base game outcomes are determined based upon base game paytables and a base game bingo card. The side bet game is evaluated against side bet game paytables (e.g., different from the base game paytables) and a different bingo card than the base game bingo card. The side bet bingo card may not be eligible for a game ending win condition in the base game and may be used only to determine the payout of the side bet game. The base game bingo card may be the only bingo card that is eligible for the game ending win condition. When both the base game and the side bet game are played at the same time, the base game and the side bet game may be provided at the same time (e.g., and outcomes thereof may be displayed at substantially the same time or simultaneously).

The bingo card for the side bet game may be randomly selected. Certain bingo cards that are eligible for selection may be golden bingo cards. When a golden bingo card is selected, the progressive associated with the side bet game may be eligible to be won (e.g., as explained herein with respect to the different side bet games). When a standard (e.g., non-gold) bingo card is selected, the progressive associated with the side bet game may not be eligible to be won. Gold bingo cards may be displayed differently from standard bingo cards (e.g., a “glow” may be displayed around gold bingo cards to communicate that the progressive is eligible to be won).

The side bet functionality may be provided to accommodate multiple denominations and/or wager amounts within the same game (e.g., the single game including the base game and the side bet game-in other words, a combination game). Accordingly, technical improvements to meters and reporting are also provided by the present disclosure in order to support multiple denominations and/or wager amounts being in the same game. For reporting purposes (e.g., to a backend system), a single game play request and win information needs to be metered for the overall play which may include multiple denominations and/or wager amounts (e.g., including both base game inputs and outputs as well as side bet game inputs and outputs). To support the base game and side bet game being played at different denominations and/or wager amounts, the overall game (e.g., the combination game) is metered as a 1-cent denomination game and has unique paytables that are metered and reported as a composite of the base game plus the side bet game and its denomination and/or wager amount. The RTP may be reported and calculated as a combined RTP for the overall game combination (e.g., the base game and the side bet game).

Each side bet game and base game combination may be stored with separate game meters. For instance, a selectable composite paytable for each unique side bet game and base game combination may be provided. A meter associated with a base game and side bet game combination (e.g., the combined base game and side bet, when a player has opted in to the side bet game) may update only when a bet was placed for that base game and side bet game combination (e.g., and where an outcome is provided based at least in part upon the composite paytable associated with that base game and side bet game combination).

Help pages may include relevant side bet game and progressive information. The help pages may include bingo patterns that are tied to the side bet game. Because the help pages and paytables are stored at a server, new paytables and/or different math for the side bet games may be implemented remotely (e.g., via a connection to gaming devices) as well as help pages associated therewith. This is an additional improvement to the overall system by allowing help pages and paytables to be easily changed at a single location and then pushed out to the remote devices as needed. This saves on time and memory space.

For example, a server may store side games and/or wager amounts by game title ID in order to identify which help pages and/or paytables to transmit to gaming devices. Help pages and/or paytables may be transmitted to a particular gaming device for all games and/or denominations available for play at that gaming device.

In other words, a server may store help pages and/or pay tables for various games at various denominations. The server may identify which games and/or denominations are available at a particular gaming device and transmit the corresponding help pages and/or pay tables to that gaming device (e.g., for display to a player).

The server may also generate game outcomes. For instance, the server may receive a game ID and a wager amount from a gaming device for a play of a game. Based on the paytable(s) for that game ID and the wager amount, the server may transmit a message associated with a game outcome (e.g., randomly determined at the server, associated with, for instance, a bingo card and a ball call) to the gaming device and the gaming device may provide the game outcome. Notably, in these examples, the gaming device may not “know” which game is being provided (e.g., a bingo game) or how the game outcomes are generated, it may just be “told” by the server which outcome to provide, and provide that outcome. Thus, gaming devices described herein are more flexible in that games provided at the gaming devices may be managed and/or adjusted remotely (e.g., at the server).

In some embodiments, an application may be provided that converts Class III paytables to Class II paytables (e.g., bingo pattern paytables). For instance, the paytables in Class III and Class II formats may include substantially the same RTP. Thus, Class III games may be taken “off the shelf” and automatically converted to Class II games by the automatic generation of Class II paytables from Class III paytables. As an example, a Class II pattern file and/or table may be generated for each paytable in a Class III game in order to complete the conversion from Class III to Class II.

Technical problems addressed by the present disclosure include: (i) inability of known systems to provide variability in base game and side bet game combinations; (ii) inability of known systems to accept different input amounts (e.g., different wagers) for a base game and a side bet game; (iii) inability of known systems to provide a progressive jackpot that is (e.g., only) eligible to be provided in a side bet game (e.g., based upon evaluation of a bingo card that is different from a bingo card for a base game); (iv) inability of known systems to provide different output amounts for a base game and a side bet game and report and/or store the different output amounts as a single output amount for a play of a combination game (e.g., including the base game and the side bet game); (v) inability of known systems to combine and/or convert denominations of input amounts; (vi) inability of known systems to normalize output data (e.g., associated with a base game output amount and a side bet game output amount) based upon output amounts (e.g., generated based upon different paytables) for a single play of a combination game; (vii) inability of known systems to generate and/or automatically update help pages (e.g., including paytables such as bingo patterns) for an electronic game; (viii) inability of known systems to generate help pages at a server and stream and/or transmit data to an electronic gaming device that causes the help pages to be displayed based upon a configuration (e.g., available games, denominations, etc.) of the electronic gaming device; (ix) inability of known systems to automatically generate (e.g., at a server) and/or provide (e.g., to an electronic gaming device) updated paytables including bingo patterns based upon a requested change in RTP; and (x) inability of known systems to provide help data for an electronic game as an overlay on game content (e.g., to allow Class III games to be efficiently converted to Class II games mostly as-is).

Technical solutions provided by the systems and methods disclosed herein include: (i) ability to provide variability in base game and side bet game combinations; (ii) ability to accept different input amounts (e.g., different wagers) for a base game and a side bet game; (iii) ability to provide a progressive jackpot that is (e.g., only) eligible to be provided in a side bet game (e.g., based upon evaluation of a bingo card that is different from a bingo card for a base game); (iv) ability to provide different output amounts for a base game and a side bet game and report and/or store the different output amounts as a single output amount for a play of a combination game (e.g., including the base game and the side bet game); (v) ability to combine and/or convert denominations of input amounts; (vi) ability to normalize output data (e.g., associated with a base game output amount and a side bet game output amount) based upon output amounts (e.g., generated based upon different paytables) for a single play of a combination game; (vii) ability to generate and/or automatically update help pages (e.g., including paytables such as bingo patterns) for an electronic game; (viii) ability to generate help pages at a server and stream and/or transmit data to an electronic gaming device that causes the help pages to be displayed based upon a configuration (e.g., available games, denominations, etc.) of the electronic gaming device; (ix) ability to automatically generate (e.g., at a server) and/or provide (e.g., to an electronic gaming device) updated paytables including bingo patterns based upon a requested change in RTP; and (x) ability to provide help data for an electronic game as an overlay on game content (e.g., to allow Class III games to be efficiently converted to Class II games mostly as-is).

Further technical benefits provided by the present disclosure include (i) displaying large quantities of complex information in a relatively small display area; (ii) communicating complex information with easy-to-understand animations on a display; (iii) clearly indicating when a player has activated or deactivated a side bet game; (iv) efficiently communicating different game rules for games on the display during game play; and (v) providing versatility as to which devices (e.g., EGMs, mobile devices, etc.) the games described herein may be played on because of the efficient display area designs described herein and/or the ability to update paytables remotely (e.g., at a server in communication with a gaming device).

For instance, various interface improvements are provided herein to efficiently and effectively communicate information. As examples, different animations are provided depending upon whether a side bet game is activated, which side bet game is activated, and/or whether a bingo card for a side bet game is a bingo card that is eligible to be evaluated with respect to a side bet progressive jackpot (e.g., a gold bingo card).

Example embodiments described herein may be provided in combination or in isolation to summarize and present game mechanics in a manner that improves the efficiency of computer systems (e.g., electronic gaming systems including electronic gaming devices). Each example system provides an improved user interface displaying a limited set of information to players, potentially within a small screen, such that players can more quickly understand the current status of the game and navigate to the next play of the game. The systems and methods provide improved display device functionality (e.g., on a gaming device) by providing multiple visual indicators that communicate game mechanics described herein to players. Because of at least the easily-understood animations, symbols, and indicators displayed, the games described herein can be played and understood on a single screen substantially smaller than some of the EGMs described herein (e.g., a mobile device such as a cell phone), thus removing the need for multiple displays with complex information screens including lengthy text.

Technical improvements provided by the present disclosure include the ability to provide variability in base game and side bet game combinations, the ability to accept different input amounts (e.g., different wagers) for a base game and a side bet game, and the ability to provide a progressive jackpot that is (e.g., only) eligible to be provided in a side bet game (e.g., based upon evaluation of a bingo card that is different from a bingo card for a base game).

For example, different base game and side bet game combinations may be provided at different wager amounts (e.g., if desired). The different side bet games may be associated with different facades that are associated with different game outcomes. In some instances, the same bingo pattern evaluation may occur (e.g., regardless of which side bet game is selected) for a play of a side bet game. The selected side bet game may determine which facade is displayed to communicate the outcome of the play of the side bet game. For instance, different facades for the different side bet games may be stored in one or more lookup tables (e.g., storing facades as being associated with output amounts) so that when a game outcome is determined, a lookup can be performed for an appropriate facade to be displayed (e.g., based upon the selected side bet game and the output for the selected side bet game). Storing different facades for different outputs in the organized fashion described herein improves computer efficiency of electronic gaming devices because the electronic gaming devices can display outcomes by performing a simple lookup (e.g., where the game evaluation (e.g., a Class II game evaluation) is performed remotely at a server).

Further technical improvements provided by the present disclosure include the ability to provide different output amounts for a base game and a side bet game and report and/or store the different output amounts as a single output amount for a play of a combination game (e.g., including the base game and the side bet game), the ability to combine and/or convert denominations of input amounts, and the ability to normalize output data (e.g., associated with a base game output amount and a side bet game output amount) based upon output amounts (e.g., generated based upon different paytables) for a single play of a combination game.

For example, data integrity is improved because input data (e.g., associated with wager amounts) and output data (e.g., associated with output amounts) is normalized and/or converted into a reporting format that is consistent across the various base game and side bet game combinations described herein. For instance, different wagers are accepted for a base game and a side bet game, different paytables are utilized to determine outcomes for the base game and the side bet game, different output amounts are provided for the base game and the side bet game, and, notably, input data and output data are reported in a consistent format (e.g., a one-cent denomination total bet for the combination game and a total output amount for the combination game). Various technical improvements are thereby provided such as, for instance, based upon how the input data and output data is stored and/or reported, the ability to analyze and/or compare the input data and/or output data (e.g., for RTP purposes, such as ensuring each base game and side bet game combination is achieving a target RTP).

Additional technical improvements provided by the present disclosure include the ability to generate and/or automatically update help pages (e.g., including paytables such as bingo patterns) for an electronic game, the ability to generate help pages at a server and stream and/or transmit data to an electronic gaming device that causes the help pages to be displayed based upon a configuration (e.g., available games, denominations, etc.) of the electronic gaming device, the ability to automatically generate (e.g., at a server) and/or provide (e.g., to an electronic gaming device) updated paytables including bingo patterns based upon a requested change in RTP, and the ability to provide help data for an electronic game as an overlay on game content (e.g., to allow Class III games to be efficiently converted to Class II games mostly as-is).

For example, based upon the help page and/or paytable generation at a server (e.g., a backend server), computer resources and computer efficiency are saved at electronic gaming devices in communication with the server because memory-intensive help pages and/or pay tables do not need to be stored at the electronic gaming devices. Further, because the paytables are stored at the server, computer efficiency of electronic gaming devices is improved because game outcomes (e.g., based upon analysis of a bingo card, ball call, and paytable including bingo patterns) are determined remotely at the server instead of locally at the electronic gaming devices.

Further, because the help pages can be generated, transmitted, and/or updated at the server, Class III games can easily be converted to Class II games because help pages can be provided remotely from the server (e.g., and updated as needed at the server) and the electronic gaming device can simply request an output from the server (e.g., based upon a configuration of the electronic gaming device and input data from the electronic gaming device) and provide and/or display game outcomes that correspond to the output received from the server. In other words, the electronic gaming device may act as a “thin client” that provides facades that correspond to the game outcomes without needing to generate the game outcomes themselves.

Additionally, technical security improvements are provided based upon the game outcomes and/or help pages being stored at the server. For instance, concerns regarding local tampering at the electronic gaming device are alleviated because paytables and help pages are stored at the server and game outcomes are generated at the server.

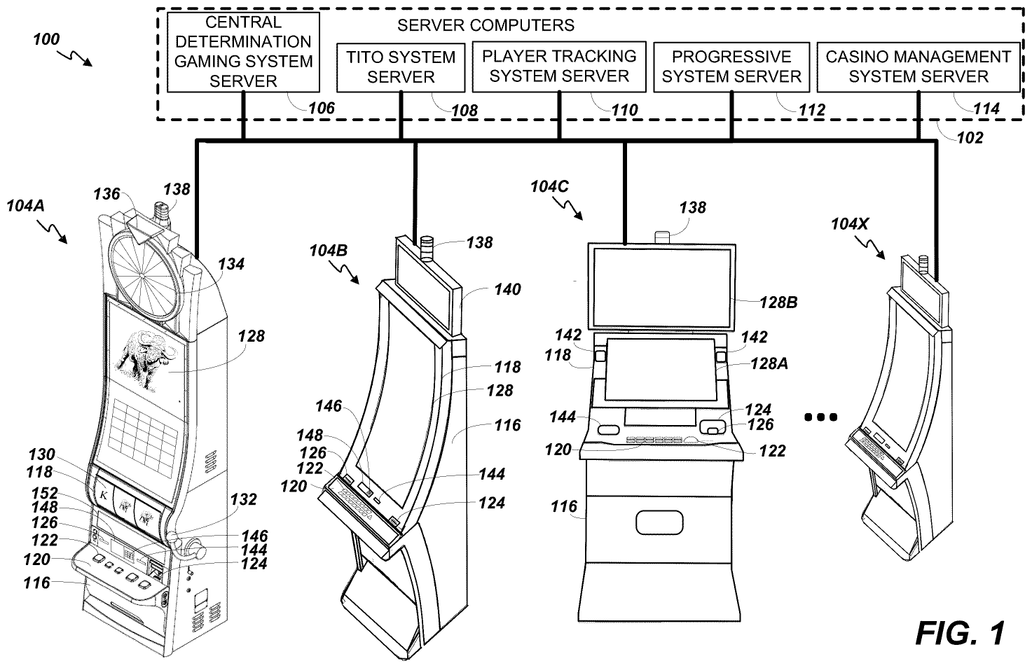

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

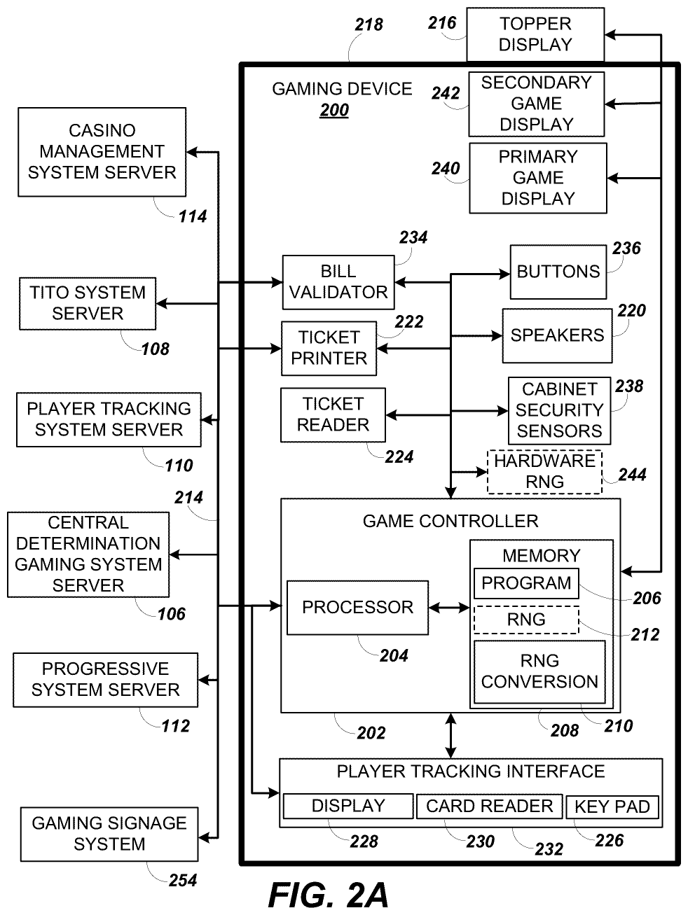

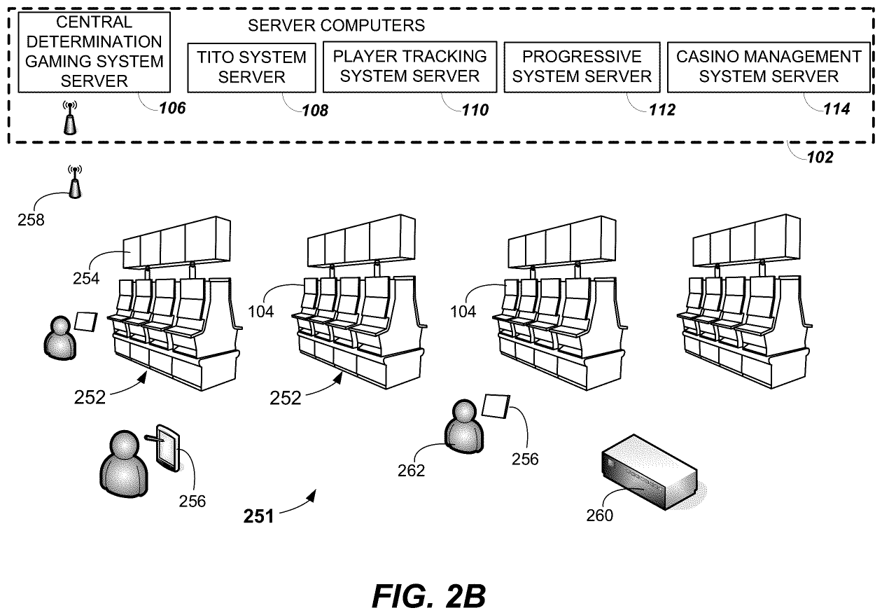

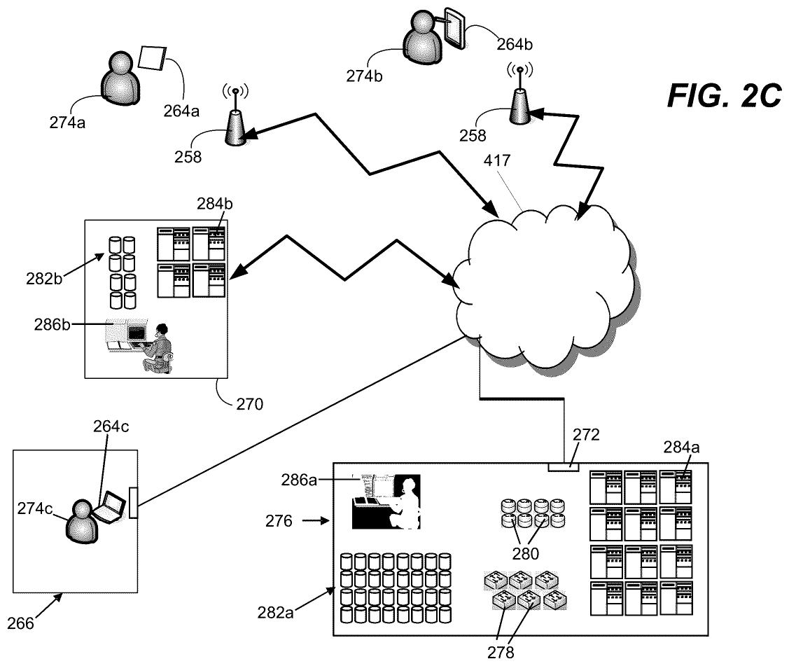

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

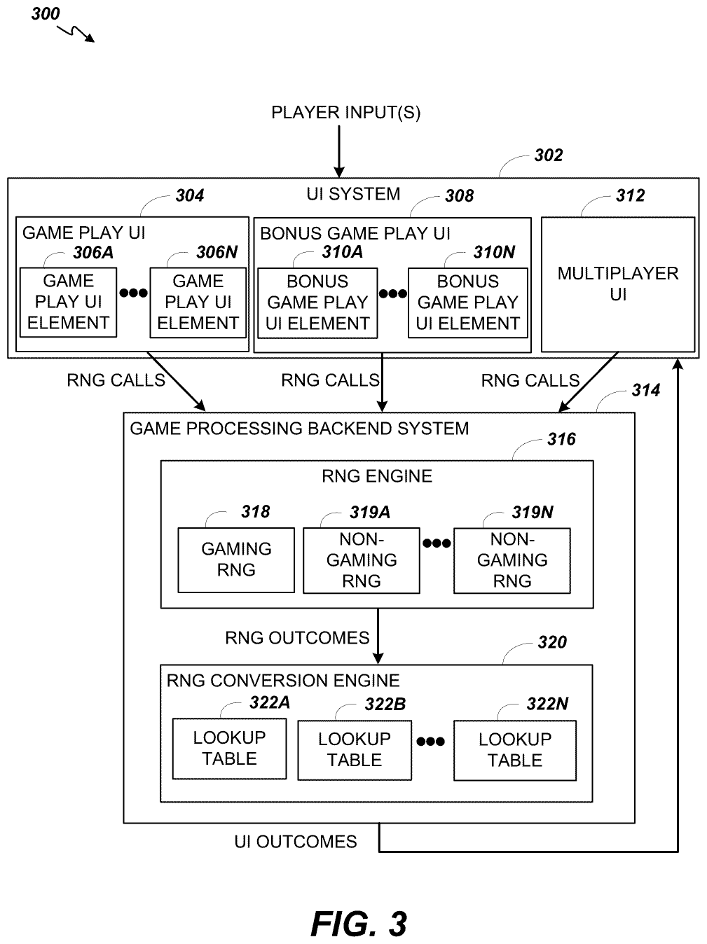

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

### Side Bet Games

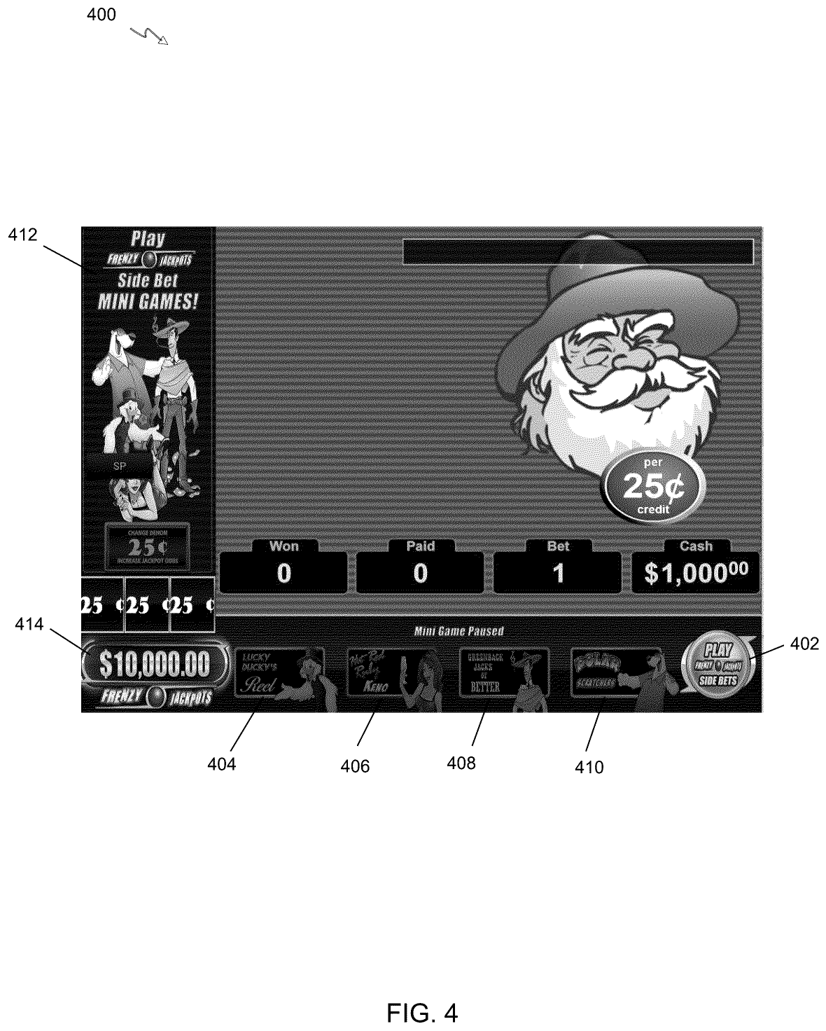

FIG. 4 illustrates an example screenshot and/or interface 400 of an electronic game including a side bet progressive, in accordance with the present disclosure. As shown in FIG. 4, a player has not yet opted in to a side bet game. Accordingly, a selector 402 is displayed in a first state to indicate that selection thereof will result in opting in to the side bet game.

Side bet game selectors 404-410 are also displayed (e.g., dimmed/grayed out because the side bet game has not yet been opted in to) to indicate different side bet game options are available. In an example embodiment, side bet game selector 404 corresponds to a reel game, side bet game selector 406 corresponds to a keno game, side bet game selector 408 corresponds to a card game, and side bet game selector 410 corresponds to a scratch-off game.

Further, FIG. 4 shows a side bet game message 412 indicating that side bet games are available to be displayed and progressive meter 414 indicates a current progressive amount for a progressive jackpot that is eligible to be won in the side bet games (e.g., and not the base game).

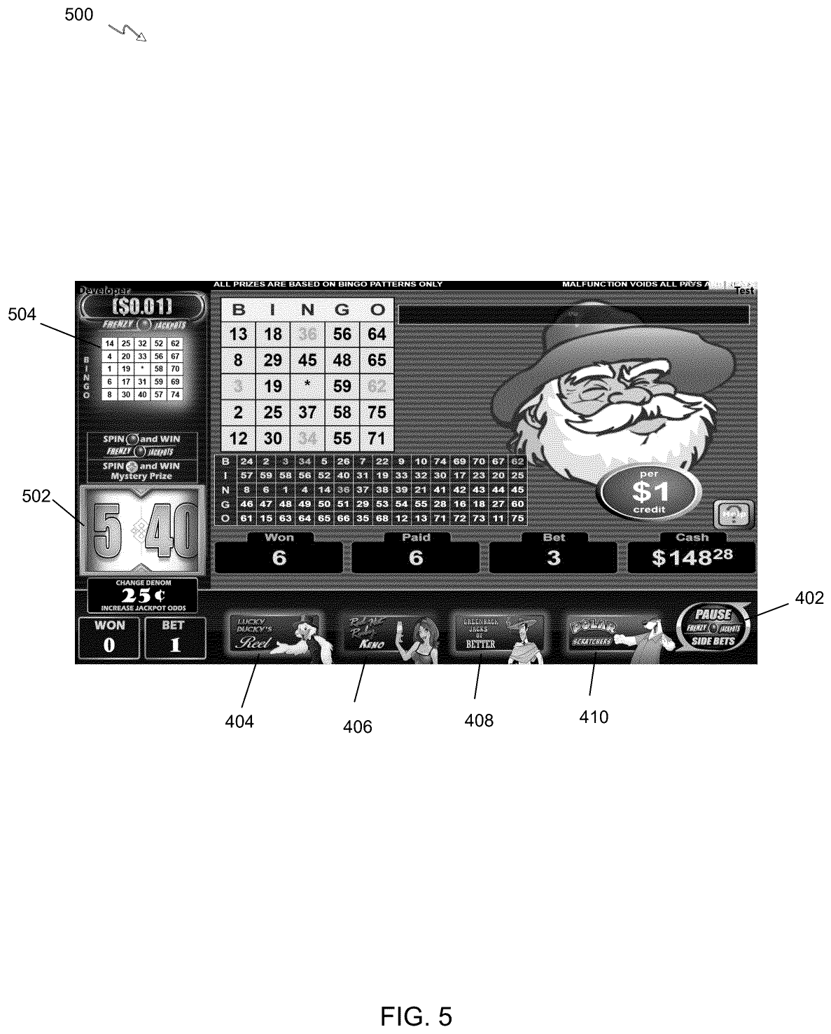

FIG. 5 illustrates an example screenshot and/or interface 500 of an electronic game including a side bet progressive, in accordance with the present disclosure. As shown in FIG. 5, a player has opted in to the side bet game. Accordingly, selector 402 is displayed in a second state to indicate that selection thereof will now result in opting out of (e.g., pausing) the side bet game.

Further, selectors 404-410 are illuminated to indicate that a side bet game may be selected. In an example embodiment, upon opt in (e.g., selection of selector 402), a side bet game associated with selector 404 may automatically be selected until a player selects a different side game. As shown in FIG. 5, the reel game associated with selector 404 has been selected, and thus the reel game (e.g., including a horizontally-spinning reel) is shown as a side bet game 502.

FIG. 5 also illustrates an example of a golden bingo card 504 being displayed (e.g., a bingo card with an illuminated/highlighted border). A bingo card for the side bet game may be randomly selected. Certain bingo cards that are eligible for selection may be golden bingo cards 504. When golden bingo card 504 is selected, the progressive associated with the side bet game may be eligible to be won. When a standard (e.g., non-gold) bingo card is selected, the progressive associated with the side bet game may not be eligible to be won.

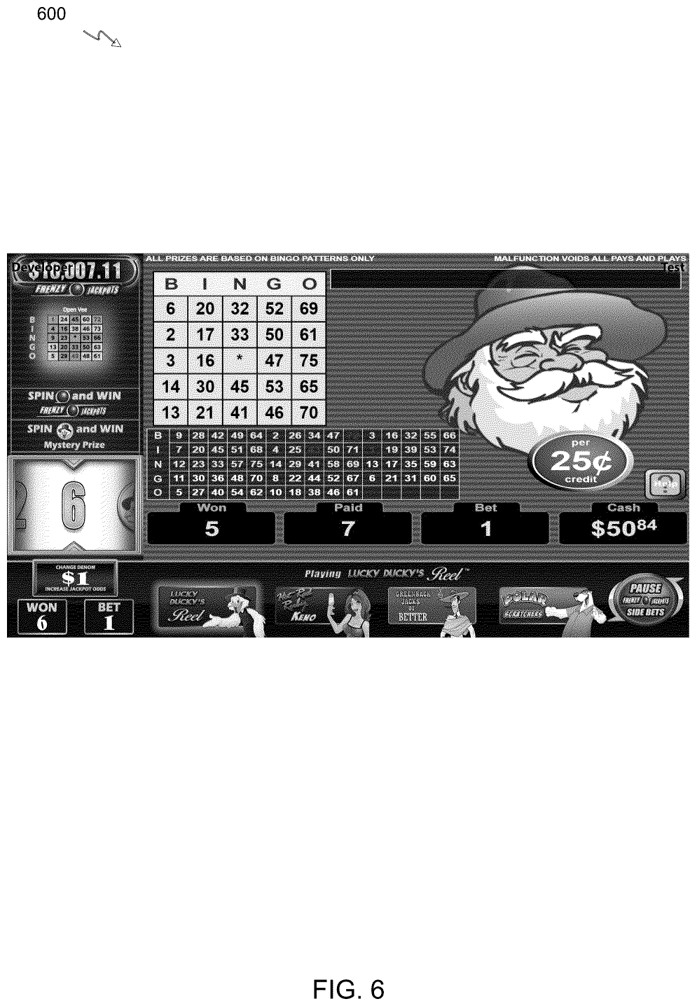

FIG. 6 illustrates another example screenshot and/or interface 600 of an electronic game including a side bet progressive where a reel game is selected as the side bet game, as shown in FIG. 5.

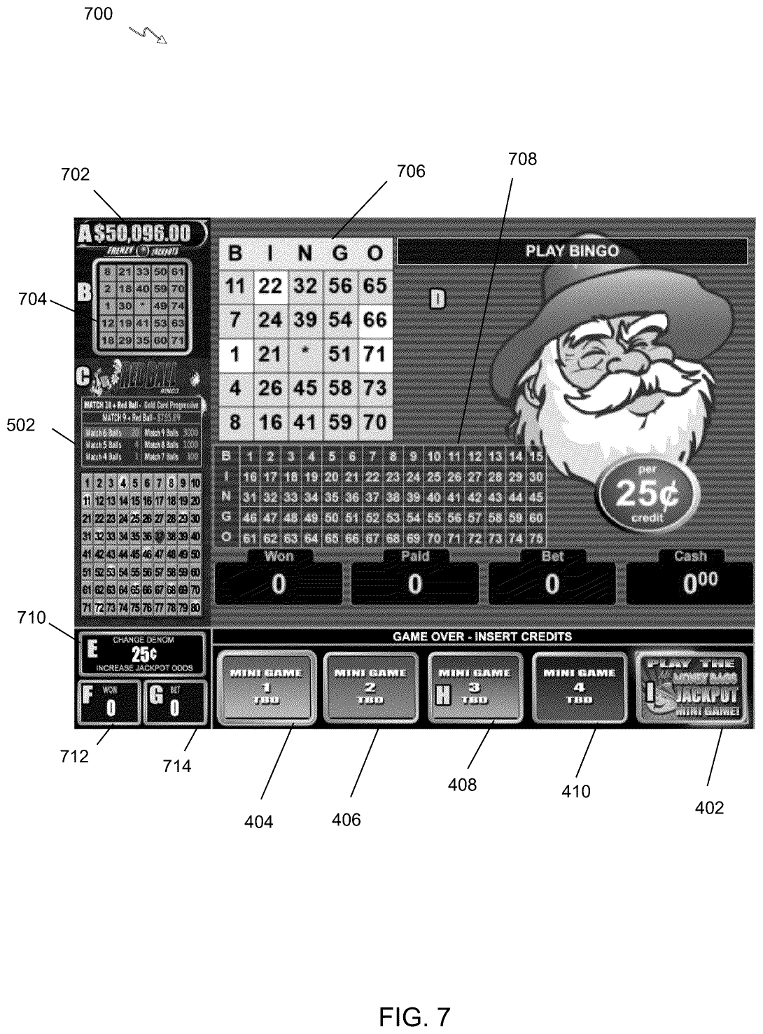

FIG. 7 illustrates another example screenshot and/or interface 700 of an electronic game including a side bet progressive where a player has opted in to a side bet game, in accordance with the present disclosure.

As shown in FIG. 7, a jackpot meter 702 is displayed that is associated with the progressive jackpot for the side bet game. Meter 702 may always be displayed, regardless of whether the side bet game has been opted in to or not.

A bingo card 704 for the side bet game is also displayed. Bingo card 704 may only be displayed when the side bet game has been opted in to. Further, as explained herein, bingo card 704 may only used for the side bet game and not the base game. Accordingly, a bingo card 706 for the base game is also displayed. In an example embodiment, both bingo card 704 and bingo card 706 use the same ball call 708. RTP for the side bet game may be different than RTP for the base game. In some embodiments, when side bet games are enabled (e.g., available for selection), display of the base game may be shrunk to 80% of full-size display of the base game to accommodate the side bet game.

A side bet game 502 is also displayed. Side bet game 502 may only be displayed when a player opts in to the side bet game. Selection of a side bet game may default to a lowest volatility side bet game (e.g., associated with selector 404) until a player selects a different side bet game, if desired.

A denomination 710 for the side bet game is also displayed. Display of denomination 710 may change to various denomination selection boxes/options upon selection of denomination 710. Denomination 710 may default to a lowest available denomination until a player selects a different denomination.

Further, a win meter 712 displays any amount won from playing a side bet game and may default to zero when a next play of the side bet game is initiated. A bet meter 714 is also displayed. Further, selectors 402-410 are displayed, as described herein.

As explained herein, selection of a side bet game results in the selected side bet game being displayed to communicate side bet game outcomes. Notably, the output amount provided for a play of the side bet game may be determined the same way (e.g., based upon a bingo card and a ball call) regardless of which side bet game is selected. In other words, the side bet games may just be different facades (e.g., reel game, keno game, card game, scratch-off game) to communicate bingo outcomes.

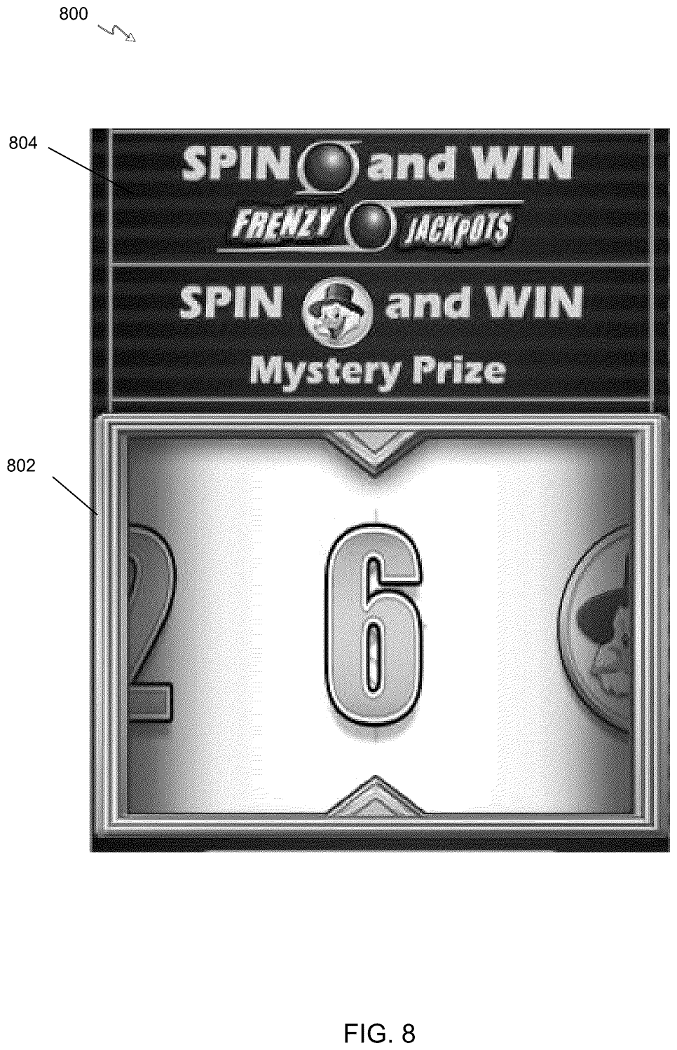

FIG. 8 illustrates an expanded view of an example screenshot and/or interface 800 of a reel side bet game (e.g., associated with selector 404). In an example embodiment, reel 802 spins horizontally during a play of the side bet game. The progressive jackpot associated with the side bet games may be provided when a red ball lands on reel 802, as shown in message 804.

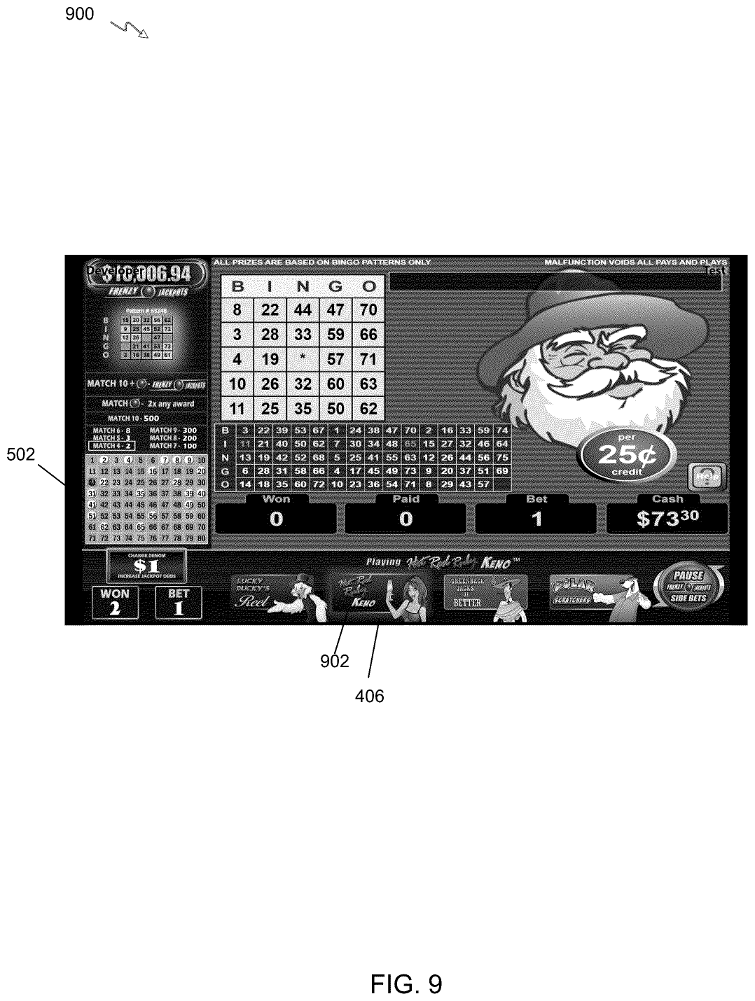

FIG. 9 illustrates an example screenshot and/or interface 900 of an electronic game including a side bet progressive when a keno side bet game is selected, in accordance with the present disclosure. Accordingly, selector 406 is displayed with a highlighted border 902 to communicate that the keno side bet game is selected and a keno game is displayed as side bet game 502.

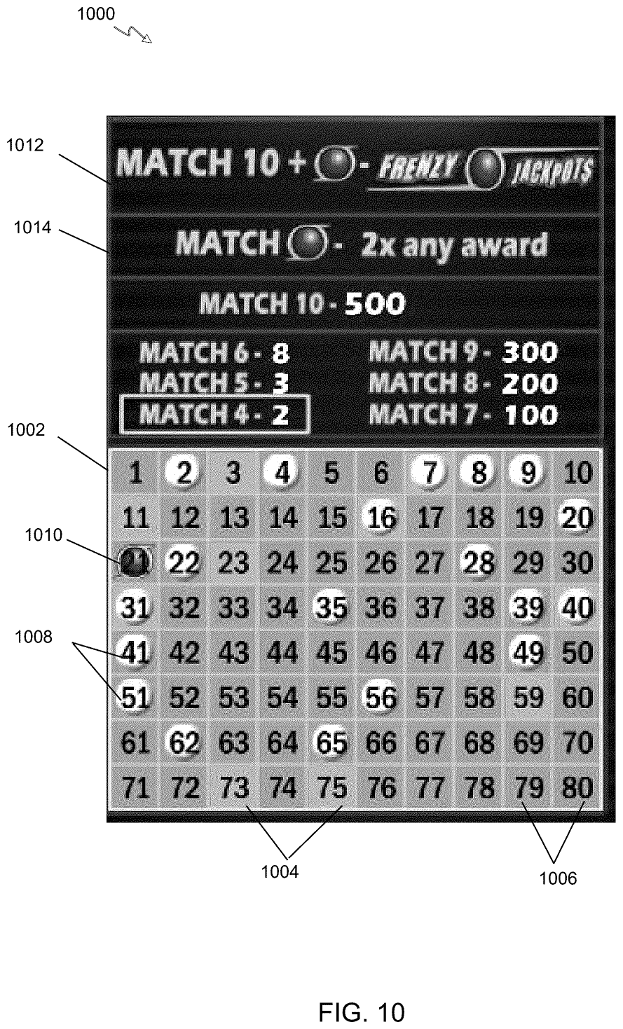

FIG. 10 illustrates an expanded view of an example screenshot and/or interface 1000 of a keno side bet game (e.g., associated with selector 406). In an example embodiment, keno card 1002 is illustrated as including a number of automatically selected symbol positions 1004 (e.g., displayed in a first color) and a number of un-selected symbol positions 1006. 20 balls 1008 may fall and land in corresponding symbol positions. A red ball 1010 may fall last. As shown in FIG. 9, the number of balls 1008 matching a selected symbol position 1004 are associated with different output amounts. If ten balls match selected symbol positions 1004 and red ball 1010 matches a selected symbol position 1004, the progressive jackpot associated with the side bet games may be provided, as shown in message 1012. Further, a red ball match may result in a multiplier being applied to an output amount, as shown in message 1014.

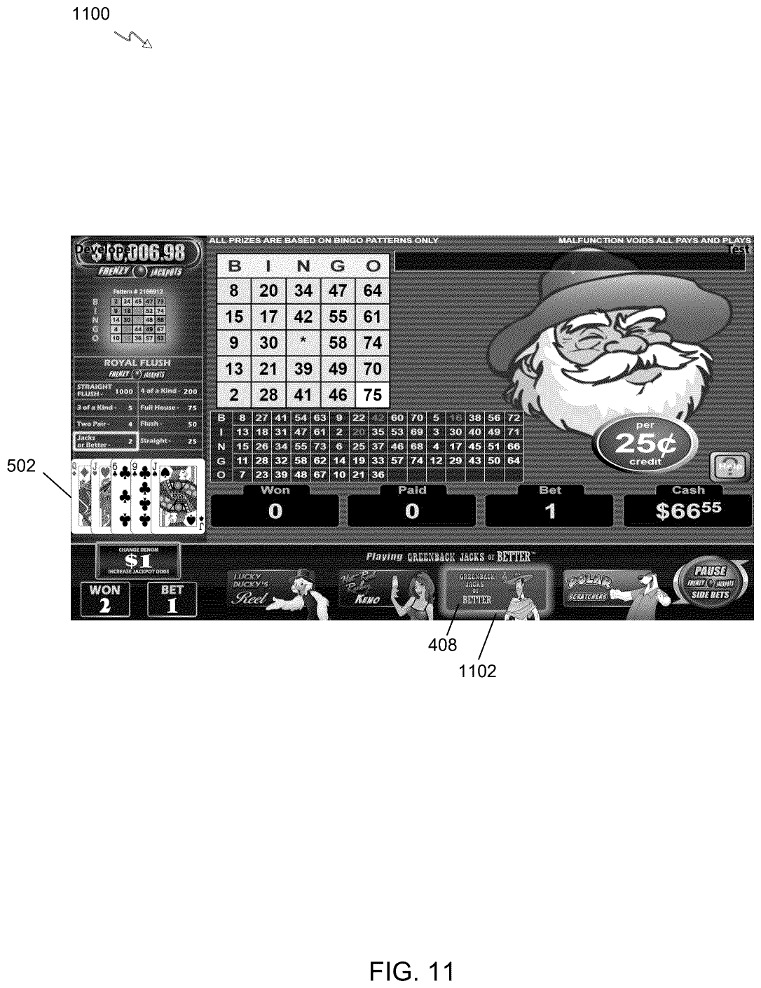

FIG. 11 illustrates an example screenshot and/or interface 1100 of an electronic game including a side bet progressive when a card (e.g., poker) side bet game is selected, in accordance with the present disclosure. Accordingly, selector 408 is displayed with a highlighted border 1102 to communicate that the card side bet game is selected and a card game is displayed as side bet game 502. In some embodiments, the card side bet game may be similar to a five card draw poker game.

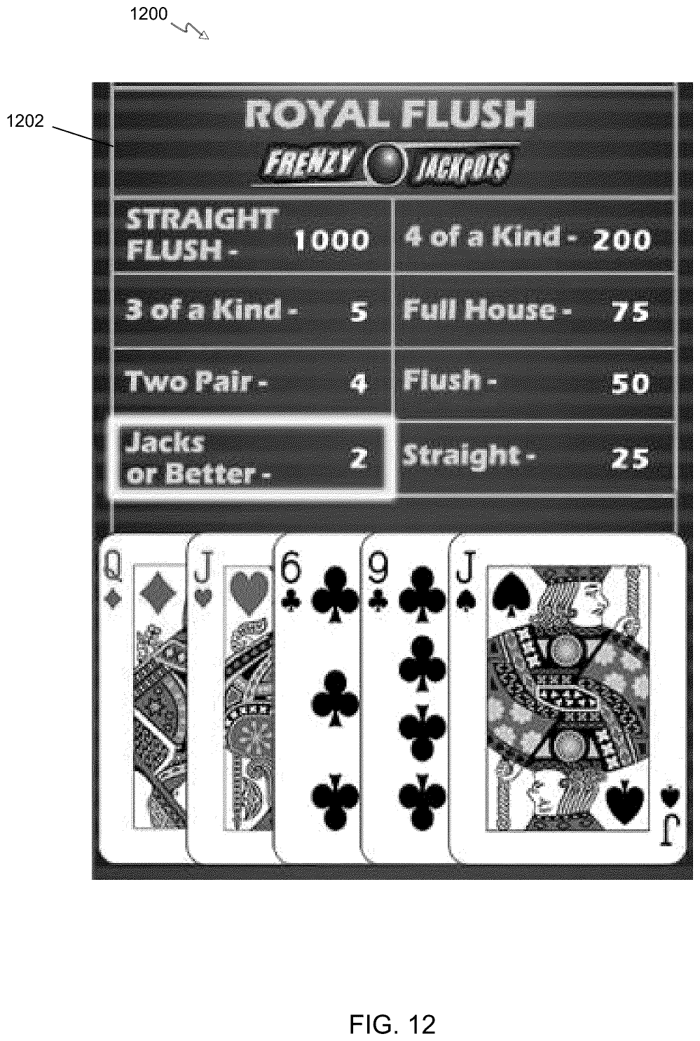

FIG. 12 illustrates an expanded view of an example screenshot and/or interface 1200 of a card game (e.g., associated with selector 408). As shown in FIG. 12, different playing card hands may be associated with different output amounts. Notably, if a royal flush is provided, the progressive jackpot associated with the side bet games may be provided, as shown in message 1202.

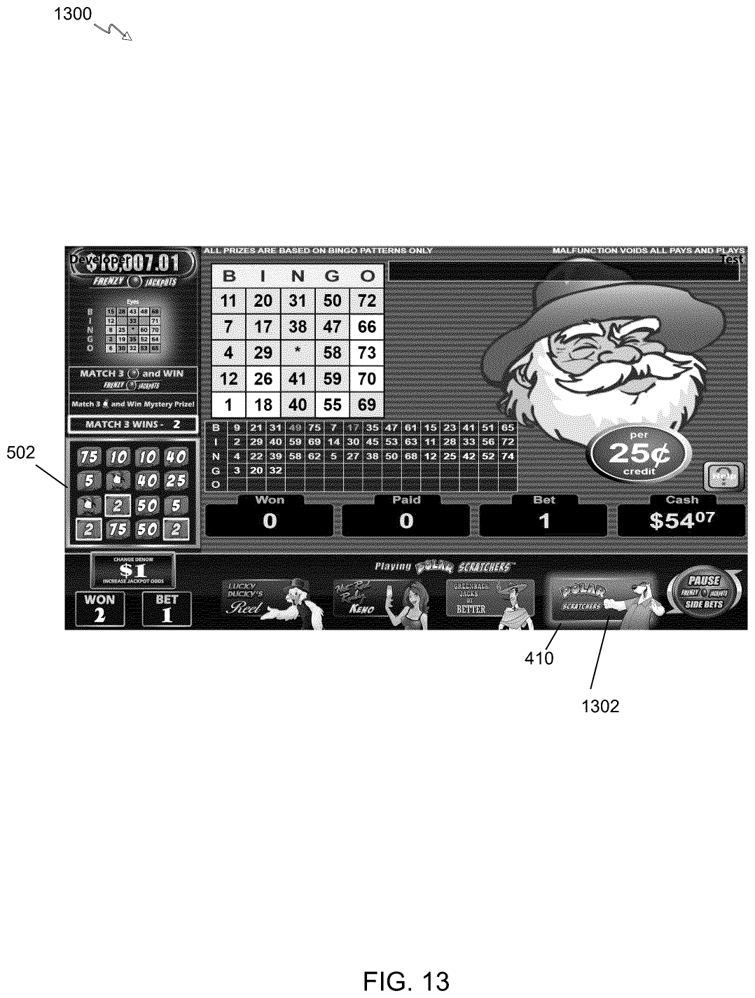

FIG. 13 illustrates an example screenshot and/or interface 1300 of an electronic game including a side bet progressive when a scratch off (e.g., a match 3 scratch off) side bet game is selected, in accordance with the present disclosure. Accordingly, selector 410 is displayed with a highlighted border 1302 to communicate that the scratch off side bet game is selected and a scratch off game is displayed as side bet game 502.

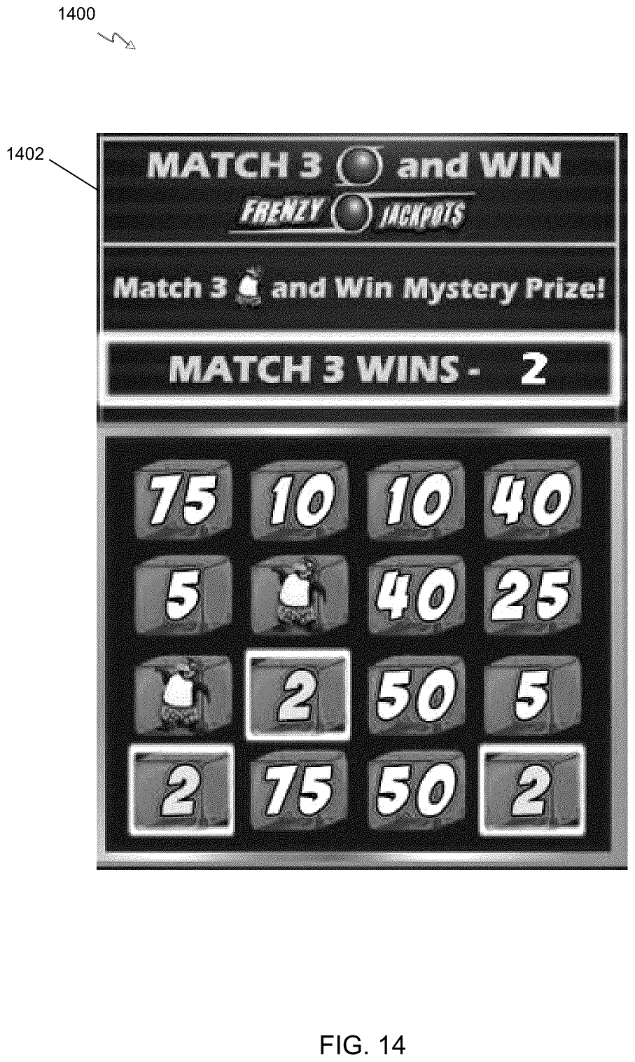

FIG. 14 illustrates an expanded view of an example screenshot and/or interface 1400 of a scratch off game (e.g., associated with selector 410). If three red ball symbols are matched (e.g., multiple red ball symbols being displayed after a scratch off), the progressive jackpot associated with the side bet games may be provided, as shown in message 1402. In some embodiments, each position of the scratcher (e.g., scratch card with symbol positions) may automatically be “scratched.”

In an example embodiment, an electronic gaming system including at least one memory with instructions stored thereon and at least one processor in communication with the at least one memory may be provided. The instructions, when executed by the at least one processor, cause the at least one processor to receive a first input wager amount for a play of an electronic game displayed in a first display area (e.g., the base game) and receive a second input wager amount for a play of a side electronic game (e.g., the side bet game) displayed in a second display area wherein the first input amount is different from the second input amount. The instructions may also cause the at least one processor to select a first bingo card for the play of the electronic game and select a second bingo card for the play of the side electronic game. The instructions may also cause the at least one processor to determine an outcome for the electronic game based upon a ball call and the first bingo card, determine an outcome for the side electronic game based upon the ball call and the second bingo card, and cause display of the outcome for the electronic game in the first display area and the outcome for the side electronic game in the second display area.

Technical improvements provided by the present disclosure include the ability to provide variability in base game and side bet game combinations, the ability to accept different input amounts (e.g., different wagers) for a base game and a side bet game, and the ability to provide a progressive jackpot that is (e.g., only) eligible to be provided in a side bet game (e.g., based upon evaluation of a bingo card that is different from a bingo card for a base game).

For example, different base game and side bet game combinations may be provided at different wager amounts (e.g., if desired). The different side bet games may be associated with different facades that are associated with different game outcomes. In some instances, the same bingo pattern evaluation may occur (e.g., regardless of which side bet game is selected) for a play of a side bet game. The selected side bet game may determine which facade is displayed to communicate the outcome of the play of the side bet game. For instance, different facades for the different side bet games may be stored in one or more lookup tables (e.g., storing facades as being associated with output amounts) so that when a game outcome is determined, a lookup can be performed for an appropriate facade to be displayed (e.g., based upon the selected side bet game and the output for the selected side bet game). Storing different facades for different outputs in the organized fashion described herein improves computer efficiency of electronic gaming devices because the electronic gaming devices can display outcomes by performing a simple lookup (e.g., where the game evaluation (e.g., a Class II game evaluation) is performed remotely at a server).

### Metering

The side bet games described herein may be enabled or disabled during configuration of a gaming device. The default value may be “Disabled” at the gaming device (e.g., the side bet game is installed at the gaming device but not enabled) for the side bet setting. Enabling the side bet setting (e.g., by a casino operator) causes a touchable button to be displayed (e.g., selector 402) that will allow the player to opt in to a side bet game. Opting into a side bet game does not initiate a spin.

The player will have the option to select different side bet game facades in a side bet window, as described herein. Each side bet game option may leverage a different paytable which could include different math. The side bet wager can be configured by the player (e.g., and be different from a base game wager).

Multiple denomination options will be available on the side bet window regardless of whether the primary game provides multiple denomination options. The paytable used for the side bet game is determined based upon the denomination selected for the side bet game. The different paytables may influence the odds of winning the side bet progressive. In other words, the player selects the denomination as an input and the system selects a paytable to use for the side bet game based upon that denomination. The selected paytable may have a different RTP than other paytables that were not selected.

To initiate a side bet wager, the player may press a SPIN button and start the game with their configured base game wager plus their side bet wager. The side bet progressive may include a single jackpot configured as a local area progressive or a single jackpot configured as a local area progressive and a second standalone progressive jackpot that can only be won on the side bet bingo card. The gaming device may only contribute to the progressive when the side bet is enabled, and the player has opted into a side bet.

If the side bet is enabled on the gaming device and opted in to, metering for each play of the combination game (e.g., the game being the base game and the side bet game) will include the amount for both the base game and the side bet game. If the side bet is enabled and opted in, the meter will be provided with a sum of the win amount for both the base game and the side bet game.

Game history may include side bet information, including the progressive wins won during gameplay in the audit menu of the gaming device, on a game server, and/or on a game history ticket. If the side bet is enabled and opted in to, in game history, all bingo cards that were played are recorded. This game history data is stored in memory for audit purposes, data analytics, and other purposes.

When the side bet game is being played, the side bet and base game may be considered one game (e.g., for reporting purposes). In an example embodiment, the paytable used to evaluate a side bet award and/or award the side bet progressive may be different from the base game paytable. Each side bet paytable in combination with the base game paytable may be stored as composite paytables. RTP reporting is based off of a total wager for a play of the game, which includes the base game and the side bet game as a combination.

Based on the total amount bet (e.g., for the base game and the side bet game), the player will have a chance for the side bet bingo card to turn into a golden bingo card, making them eligible to win the progressive. If the bingo card is golden and the pattern associated with the progressive (e.g., hot dog pattern) is hit, the progressive is won, and it does not disqualify additional interim prizes from being provided (e.g., by hitting additional bingo patterns).

Each side bet and base game bet will be shown with separate game meters (e.g., at the gaming device). For instance, a selectable composite paytable for each unique side bet game and base game combination may be provided. Different reporting meters (e.g., for reporting purposes, stored at a server) may be associated with different side bet games in combination with the base game. A reporting meter associated with a base game and side bet game combination (e.g., the combined base game and side bet, when a player has opted in to the side bet game) may update only when a bet was placed for that base game and side bet game combination (e.g., and where an outcome is provided based at least in part upon the composite paytable associated with that base game and side bet game combination).

Each game has a collection of wager category meters that are stored and are associated with the combined total bet the player made. For example, if the player wagered $1 on the base game and $0.25 on the side bet game, that play of the game played at a wager category of $1.25 and the total wager amount would reflect the sum of all the wagers placed at $1.25 wager category. The wager category (e.g., here, $1.25) may be transmitted to a backend system (e.g., an accounting server) where weighted theoretical RTP information is stored.

Notably, all side bet game and base game combinations provided herein may be recorded in a 1-cent denomination. Thus, only one denomination may show in the audit menu and all game plays may increment the meters at that one denomination (e.g., the 1-cent denomination).

For reporting of game play to a backend server (e.g., an accounting server), a single game start and game end may be reported with the total wager amount (e.g., sum of wagers for the base game and the side bet game) being sent for game start reporting and the total win amount (e.g., sum of win amounts for the base game and the side bet game) sent for game end reporting. The side bet win amount and the base game win amount combined may indicate whether a jackpot has been provided.

When side bet games are installed, each unique set bet paytable, base game, and denomination may be reported as a new unique game ID to an accounting server with 1-cent provided as the denomination so that bets are always reported at the 1-cent denomination. Since each side bet is associated with a separate paytable with its own unique RTP, each side bet amount and base game combination may be identified with a unique game identifier to the accounting server.

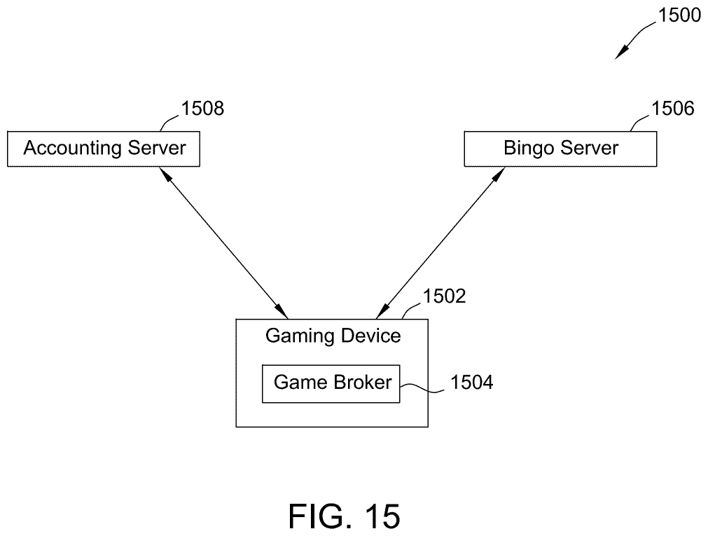

FIG. 15 illustrates an example system 1500 for electronic gaming including metering for a side bet progressive, in accordance with the present disclosure. In the example shown in FIG. 15, system 1500 includes a gaming device 1502 including a game broker software module 1504, a bingo server 1506 in communication with gaming device 1502, and an accounting server 1508 in communication with gaming device 1502.

In an example play of the electronic game, a player causes the side bet game to be activated at gaming device 1502 and selects input (e.g., wager) amounts for each of the base game and the side bet game. Game broker software module 1504 then transmits input data to bingo server 1506 that includes the input amounts for each of the base game and the side bet game. Additional data may also be transmitted to bingo server 1506 (e.g., gaming device ID, game ID (e.g., associated with a combination of the base game and the selected side bet game), etc.). Bingo server 1506 then determines and transmits output data (e.g., a bingo outcome, bingo card, and/or ball call) for each of the base game and the side bet game to game broker software module 1504. In an example embodiment, outcomes for the base game and the side bet game are determined based at least in part upon different bingo cards. Gaming device 1502 then causes display of game outcomes based upon the output data (e.g., on reels for the base game and at a side bet game display area for the side bet game (e.g., side bet game 502)).

Continuing the example play above, (e.g., including the base game play and the side bet game play) the inputs and outputs need to be metered and/or reported as a single game play. Accordingly, game broker software module 1504 converts each of the input amount for the base game and the input amount for the side game to a 1-cent denomination (e.g., regardless of the denominations for the base game and the side bet game selected by the player and utilized to determine the game outcomes for the base game and the side bet game), sums the input amount for the base game and the input amount for the side game, and transmits audit data (e.g., also including output data associated with a total output amount provided) to accounting server 1508. The audit data may include the sum of the input amount for the base game, the input amount for the side game, the 1-cent denomination, and a game ID associated with a combination of the base game and the selected side bet game.

In an example embodiment, various game plays are metered (e.g., base games at various denominations and with or without side bet games at various denominations). Different game ID's are provided for different base game and side bet game combinations. Notably, each base game and side bet game combination is reported at a denomination of 1 cent, regardless of the denominations selected by the player for the base game or side bet game.

In an example embodiment, an electronic gaming system is described that includes at least one memory with instructions stored thereon and at least one processor in communication with the at least one memory. The instructions, when executed by the at least one processor, cause the at least one processor to receive a first input amount for a play of an electronic game (e.g., the base game) associated with a first bingo card wherein the first input amount is associated with a first denomination and receive a second input amount for a play of a side electronic game associated with a second bingo card wherein the first input amount is different from the second input amount and wherein the second input amount is associated with a second denomination. The instructions also cause the at least one processor to determine an outcome for the electronic game based upon a ball call and the first bingo card wherein the outcome for the electronic game is associated with a first output amount and determine an outcome for the side electronic game based upon the ball call and the second bingo card wherein the outcome for the side electronic game is associated with a second output amount different from the first output amount. The instructions further cause the at least one processor to translate the first input amount from a first format to a reporting format wherein the reporting format is associated with a reporting denomination (e.g., a 1 cent denomination) that is different from the first denomination and the second denomination, translate the second input amount from a second format to the reporting format, combine the translated first input amount and the translated second input amount to a translated total input amount, combine the first output amount and the second output amount to a total output amount, and transmit game data to a server wherein the game data includes the translated total input amount in the reporting format and the total output amount.

Further technical improvements provided by the present disclosure include the ability to provide different output amounts for a base game and a side bet game and report and/or store the different output amounts as a single output amount for a play of a combination game (e.g., including the base game and the side bet game), the ability to combine and/or convert denominations of input amounts, and the ability to normalize output data (e.g., associated with a base game output amount and a side bet game output amount) based upon output amounts (e.g., generated based upon different paytables) for a single play of a combination game.

For example, data integrity is improved because input data (e.g., associated with wager amounts) and output data (e.g., associated with output amounts) is normalized and/or converted into a reporting format that is consistent across the various base game and side bet game combinations described herein. For instance, different wagers are accepted for a base game and a side bet game, different paytables are utilized to determine outcomes for the base game and the side bet game, different output amounts are provided for the base game and the side bet game, and, notably, input data and output data are reported in a consistent format (e.g., a one-cent denomination total bet for the combination game and a total output amount for the combination game). Various technical improvements are thereby provided such as, for instance, based upon how the input data and output data is stored and/or reported, the ability to analyze and/or compare the input data and/or output data (e.g., for RTP purposes, such as ensuring each base game and side bet game combination is achieving a target RTP).

### Help Pages

In current Class II games, help pages are typically integrated into the game itself (e.g., and stored at the gaming device where the game is installed/provided). These current games are fully “aware” of bingo and the bingo patterns that can be won (e.g., and perform at least part of the game outcome determinations, such as analysis of a bingo card and ball call against a pay table including a plurality of bingo patterns), so the bingo patterns are stored locally at the gaming device and are included in the game help screens that are provided at the gaming device when the gaming device is installed (e.g., and/or updated at the gaming device by a technician).

In example Class II games provided by the present disclosure, the Class II games are no longer aware of bingo or any of the potential pattern pays. To allow help pages to be created for these games, information regarding the paytables is installed at a server (e.g., bingo server 1506) alongside template files that describe the structure of the help pages for a specific theme (e.g., game). Help pages are then streamed electronically from the server to a gaming device (e.g., gaming device 1502) when the help pages are requested. In other words, the help pages are transmitted from a web server that exists as part of a bingo server (e.g., a server that generates bingo outcomes for Class II games). The bingo server analyzes the current configuration settings for the requesting gaming device (e.g., the current configuration settings may be transmitted to the server from the gaming device when the gaming device requests help pages), such as available denominations and payback percentages at the gaming device. Analysis of the gaming device configuration settings allows the server to transmit the correct help pages to the gaming device.

Each game theme may be associated with its own templates, such as help content, color schemes, symbol art, and/or other content specific to the theme. The content may be generated once for each theme and saved in a secure location (e.g., a source control at a server). A help generator software tool may pull these templates down from a source control server or repository when creating help packages.

Help may be constructed using standard HTML with CSS (“cascading style sheets”) styling (e.g., industry standards for web development). The help generator tool may combine this web development content with information from the available paytables for a theme to create JavaScript code that renders bingo pattern information. The HTML, CSS, and generated JavaScript code are packaged into a help package that can be installed on the server.

Help packages may be delivered as TAR files, or “Tape ARchive” files, which are like ZIP files (e.g., and are used in UNIX environments). The TAR file may contain all help content for one or more themes in a single file, the structure of which may be defined in a specific format that the server understands. The help generator tool may automatically create the TAR file in the specific format for the bingo server. Help packages in TAR format may be uploaded to the bingo server and installed using a script that is included in an installation of bingo server software.

The themes and paytables for a game may be defined with numeric ID's in a help package. For instance, help packages may be structured by theme (e.g., Theme 1, Theme 2, Theme 3, etc.), with each Theme including one or more paytables (e.g., Paytable 1, Paytable 2, Paytable 3, etc.), and with each Paytable including its own content (e.g., different bingo patterns associated with different outputs).

The paytables may include bingo patterns that are associated with different awards and a maximum number of balls called to hit a pattern and win. Each pattern is given a name, such as “Eyes” or “Hot Dog,” and is based on the shape the pattern creates on a bingo card when it is daubed. The platform needs to know these pattern names when causing display of winning pattern names on-screen for the player to see. These patterns are displayed when a prize is provided and are also displayed during the game's attract sequence (e.g., when the game is not being played). In both cases, the pattern names come from content that the help generator tool includes in a theme's help package that is stored at bingo server 1506 and transmitted to the gaming device.

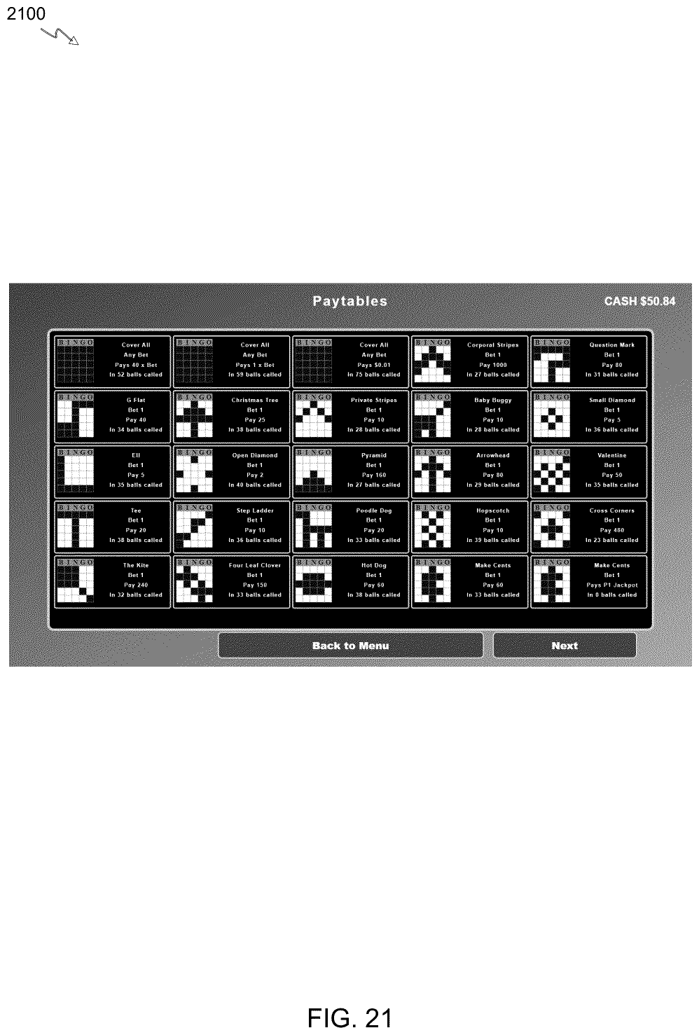

Paytables may be XML files that define bingo patterns as a 5×5 grid using a left-to-right, top-to-bottom convention. For example, the pattern “Eyes” may be defined as the spots to the immediate upper left and upper right of the center spot, with ‘1’ meaning ‘daubed’ (e.g., <PatternMap>0000001010000000000000000</PatternMap>). The help generator tool may read this information and generate JavaScript code to render the pattern on-screen for the player. The help generator tool may also parse paytable packages to determine the pattern names, win frequencies, and award amounts for winning patterns. This information is included in the information that is displayed on help pages at the gaming device (e.g., as shown in FIGS. 21, 23, and 24).

Help pages may include relevant side bet game and progressive information. The help pages may include the patterns that are tied to the side bet game. Because the help pages and paytables are stored at a server (e.g., bingo server 1506), new paytables and/or different math for the side bet games may be implemented remotely (e.g., via a connection to gaming devices) as well as help pages associated therewith. In other words, desired changes in RTP (e.g., by a gaming establishment) may be implemented remotely (e.g., at bingo server 1506) instead of a technician needing to physically go to a gaming device and causing the gaming device to be updated. Stated another way, the gaming device acts as a “thin client” where game outcome determinations and/or determinations of help provided for a particular game are made on the backend (e.g., at bingo server 1506).

For example, a server may store side games and/or wager amounts by game title ID in order to identify which help pages and/or paytables to transmit to gaming devices. Help pages and/or paytables may be transmitted to a particular gaming device for all games and/or denominations available for play at that gaming device.

In other words, a bingo server (e.g., bingo server 1506) may store help pages and/or pay tables for various games at various denominations. The bingo server may identify which games and/or denominations are available at a particular gaming device (e.g., based on a message transmitted to the server from the gaming device) and transmit the corresponding help pages and/or pay tables to that gaming device (e.g., for display to a player).

The bingo server may also generate game outcomes. For instance, the bingo server may receive a game ID and a wager amount from a gaming device for a play of a game. Based on the paytable(s) for that game ID and wager amount, the bingo server may transmit a message associated with a game outcome (e.g., randomly determined at the bingo server) to the gaming device and the gaming device may provide the game outcome. Notably, in these examples, the gaming device may not “know” which game is being provided (e.g., a bingo game) or how the game outcomes are generated, it may just be “told” by the bingo server which outcome to provide, and provide that outcome. Thus, gaming devices described herein are more flexible in that games provided at the gaming devices may be managed and/or adjusted remotely (e.g., at bingo server 1506).

In some embodiments, an application (e.g., the help generator tool) may be provided that converts Class III paytables to Class II paytables (e.g., bingo pattern paytables). For instance, the paytables in Class III and Class II formats may be associated with substantially the same RTP. Thus, Class III games may be taken “off the shelf” and automatically converted to Class II games by the automatic generation of Class II paytables from Class III paytables. As an example, a Class II pattern file/table may be generated for each paytable in a Class III game in order to complete the conversion from Class III to Class II.

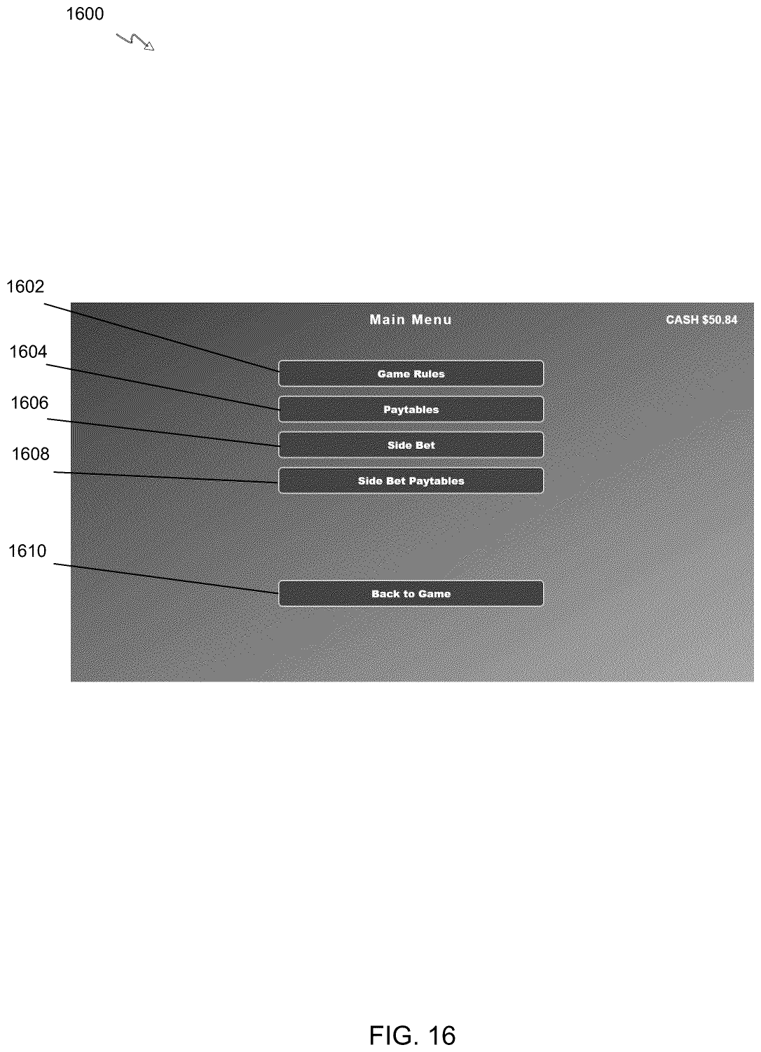

FIG. 16 illustrates an example screenshot and/or interface 1600 of a help page menu for an electronic game including a side bet progressive, in accordance with the present disclosure. Available for selection are a game rules selector 1602, a paytables selector 1604, a side bet selector 1606, and a side bet paytables selector 1608. A back to game selector 1610 allows a player to return to play of the game.

As an example, game rules for the base game, as described herein, may be displayed based upon selection of game rules selector 1602.

In an example embodiment, if a gaming device is not configured to provide the side bet game, only selectors 1602, 1604, 1610 may be provided. Further, side bet selector 1606 and side bet paytables selector 1608 may be provided at gaming devices that are configured to provide the side bet game. In other words, selectors 1606, 1608 may only be available if the server is made aware that the side bet game is enabled for the gaming device (e.g., based on one or more messages sent to the server from the gaming device).

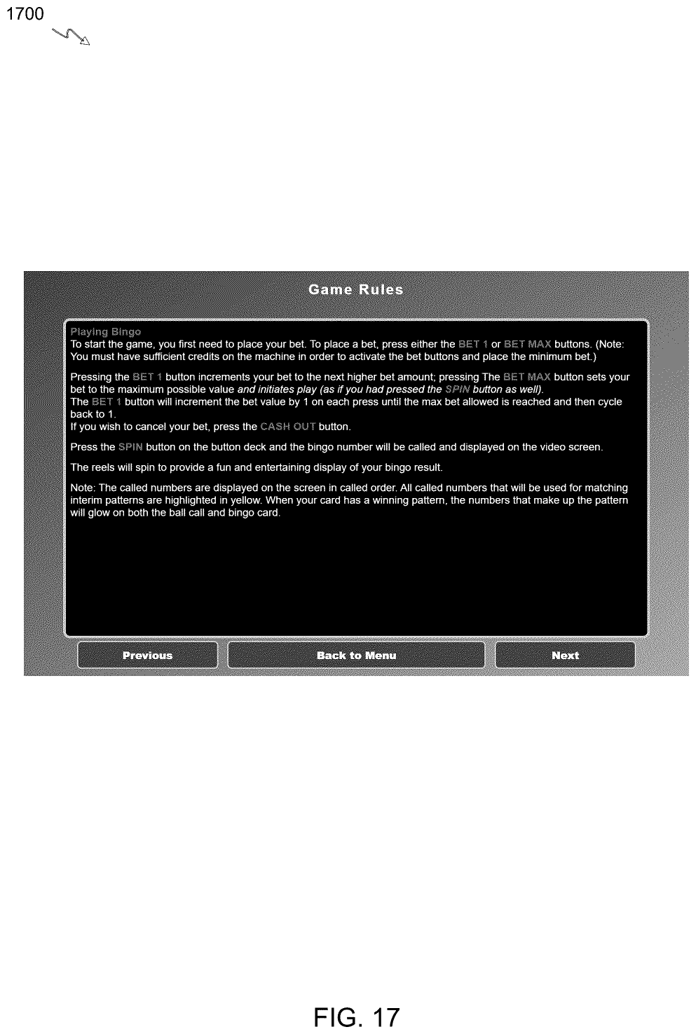

FIG. 17 illustrates an example screenshot and/or interface 1700 of game rules for an electronic game including a side bet progressive, in accordance with the present disclosure. For instance, screenshot and/or interface 1700 may be displayed based upon selection of game rules selector 1602.

In addition to the bingo patterns, the template content for a theme may also include the game rules, disclaimers, feature descriptions, and/or any other information that should be transmitted to the gaming device from the server (e.g., and shared with the player at the gaming device when help is requested). For instance, FIG. 17 illustrates an example of a help page for the example base game described herein. In an example embodiment, all of the patterns that can be won (e.g., in the base game and/or the side bet games) given the current configuration of the gaming device are rendered on one or more pages within the help pages.

Help may be divided into a series of pages, with each page being contained within its own individual HTML file. This is similar to the structure that web sites use on the World Wide Web, making creating help content simpler when using HTML authoring tools to create the template content for a game theme.

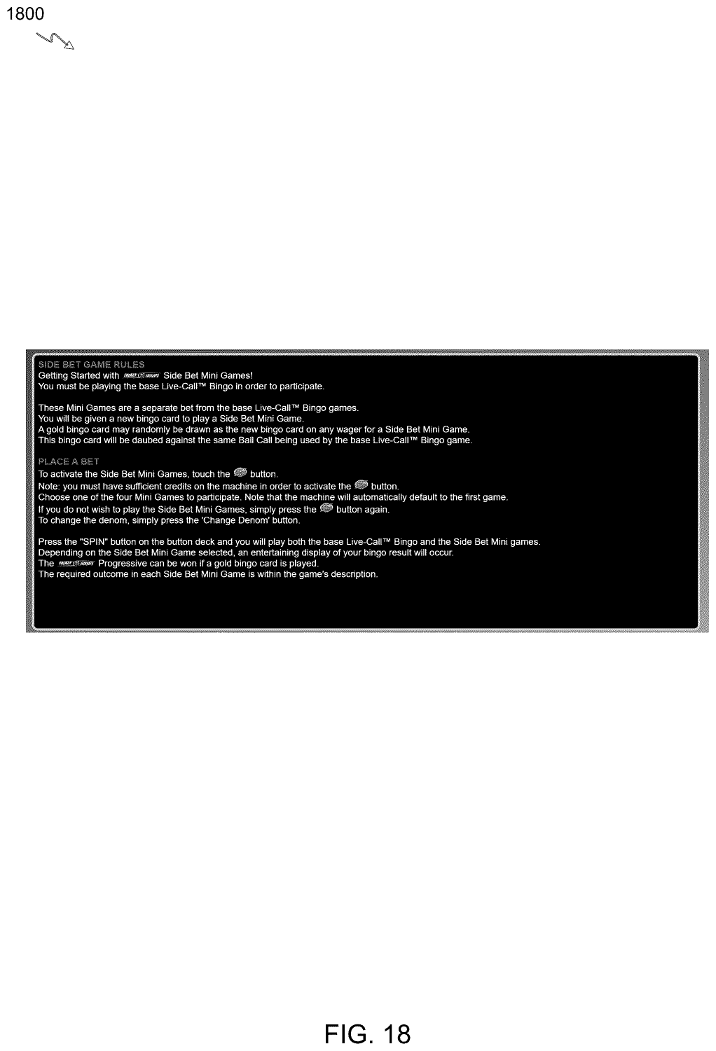

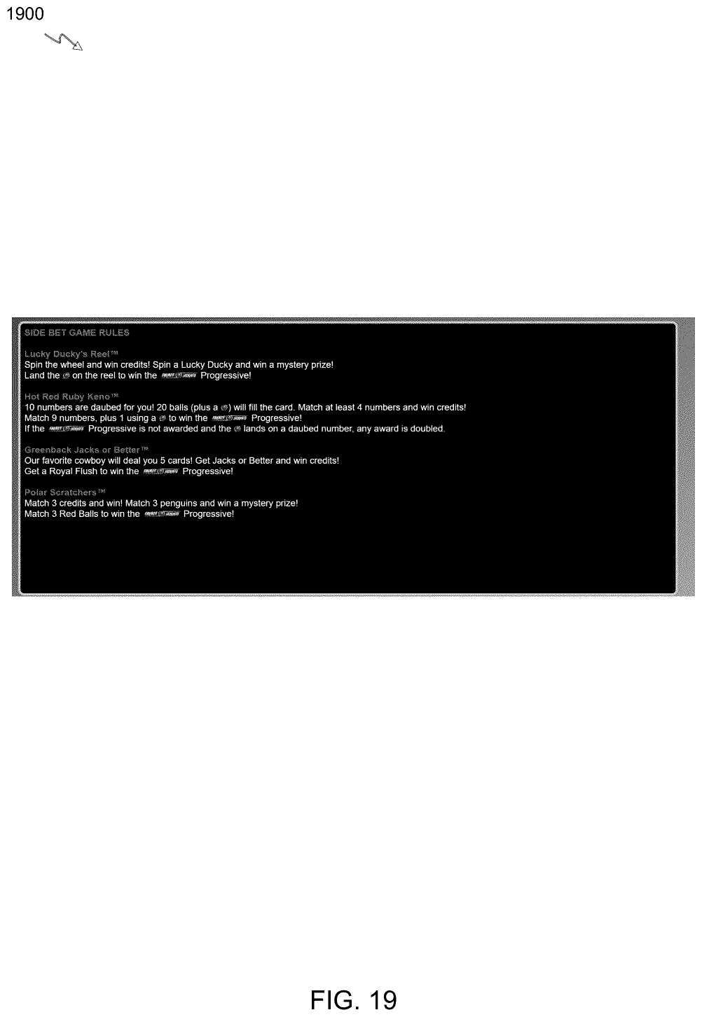

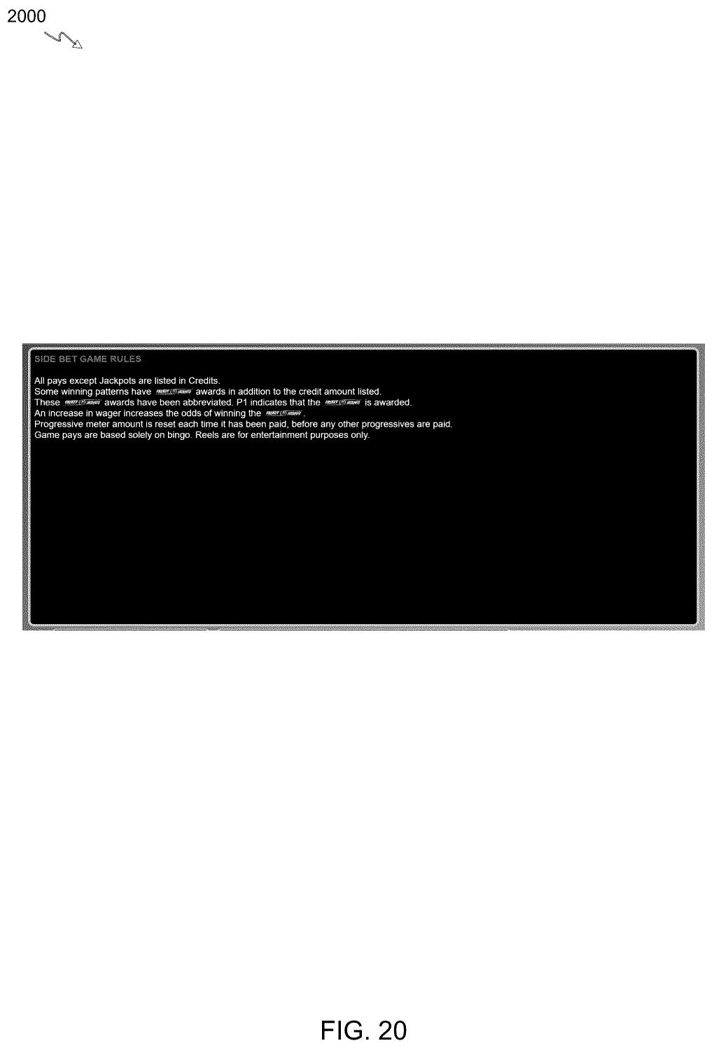

FIG. 18 illustrates another example screenshot and/or interface 1800 of game rules for an electronic game including a side bet progressive, in accordance with the present disclosure. FIG. 19 illustrates another example screenshot and/or interface 1900 of game rules for an electronic game including a side bet progressive, in accordance with the present disclosure. FIG. 20 illustrates another example screenshot and/or interface 2000 of game rules for an electronic game including a side bet progressive, in accordance with the present disclosure.

For instance, FIGS. 18-20 illustrate example screenshots and/or interfaces 1800-2000 of side bet help pages that may be hosted at a server (e.g., bingo server 1506) and transmitted to gaming devices where side bet games are provided. As an example, FIGS. 18-20 may be displayed and/or toggled through upon selection of side bet selector 1606 to illustrate how the player opts in to the side bet games and side bet game rules.

Similar to the help pages for the base game (e.g., FIG. 17), the selection of side bet selector 1606 causes display of the game rules for the side bet feature and individual games (e.g., FIGS. 18-20).

FIG. 21 illustrates an example screenshot and/or interface 2100 of a paytable for an electronic game including a side bet progressive, in accordance with the present disclosure. For instance, FIG. 21 shows paytables for a base game, as described herein, based upon selection of paytables selector 1604. Side bet selector 1606 and side bet paytables selector 1608 may be provided at gaming devices that are configured to provide the side bet game. In other words, selectors 1606, 1608 may only be available if the server is made aware that the side bet game is enabled for the gaming device (e.g., based on one or more messages sent to the server from the gaming device).

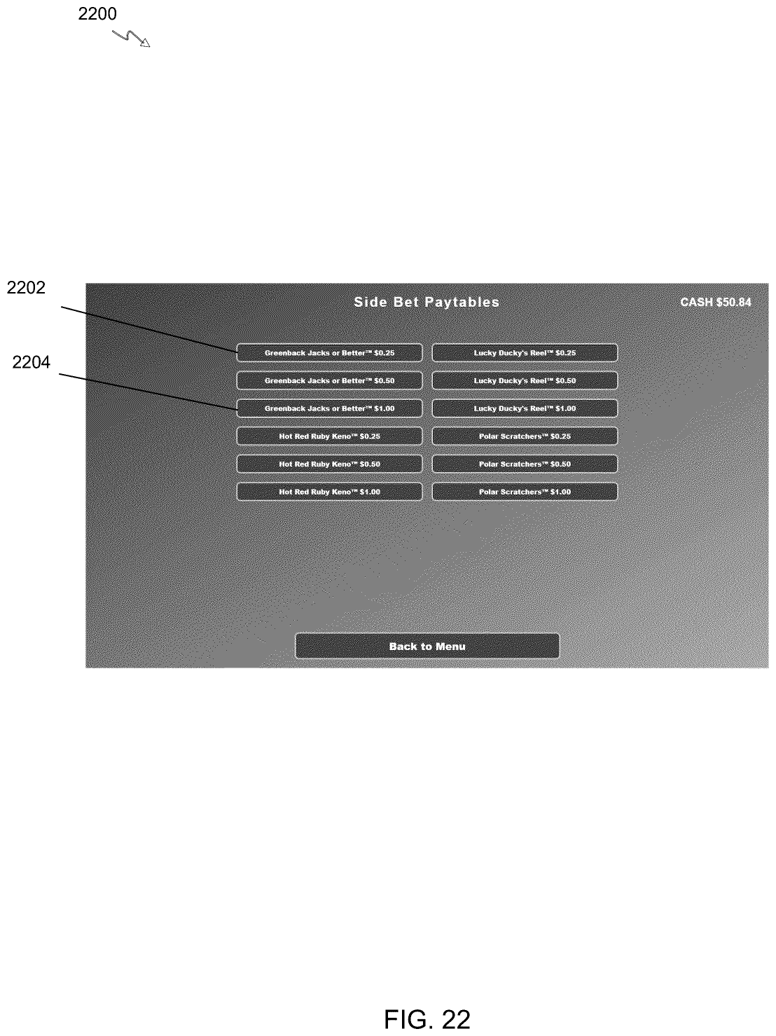

FIG. 22 illustrates an example screenshot and/or interface 2200 of a paytable menu that may be hosted at a server and transmitted to gaming devices where side bet games are provided.

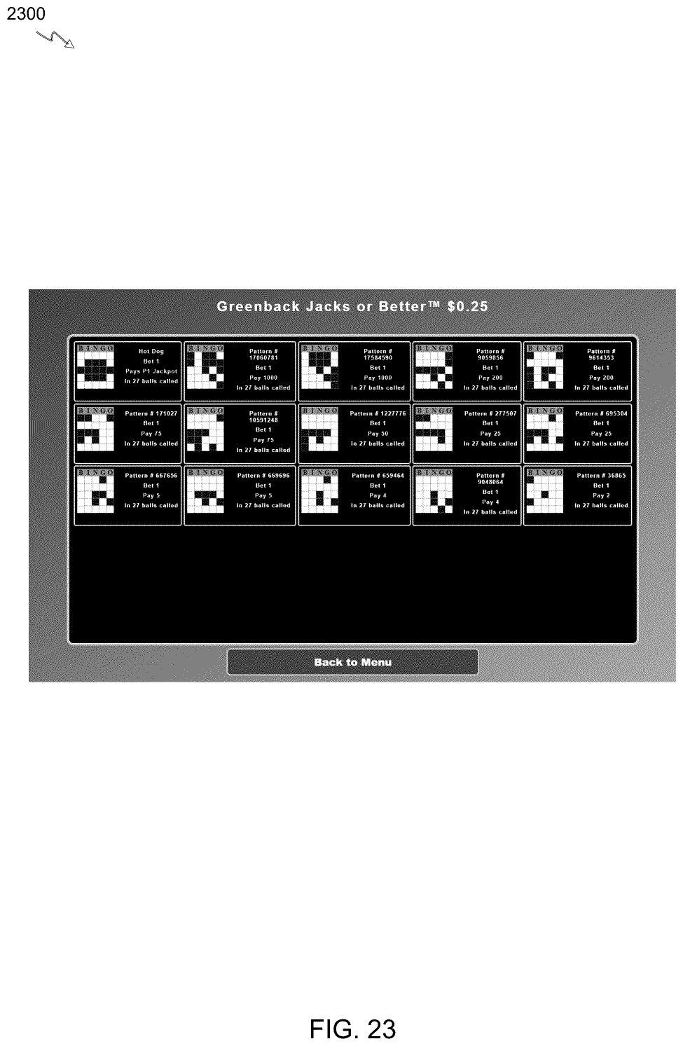

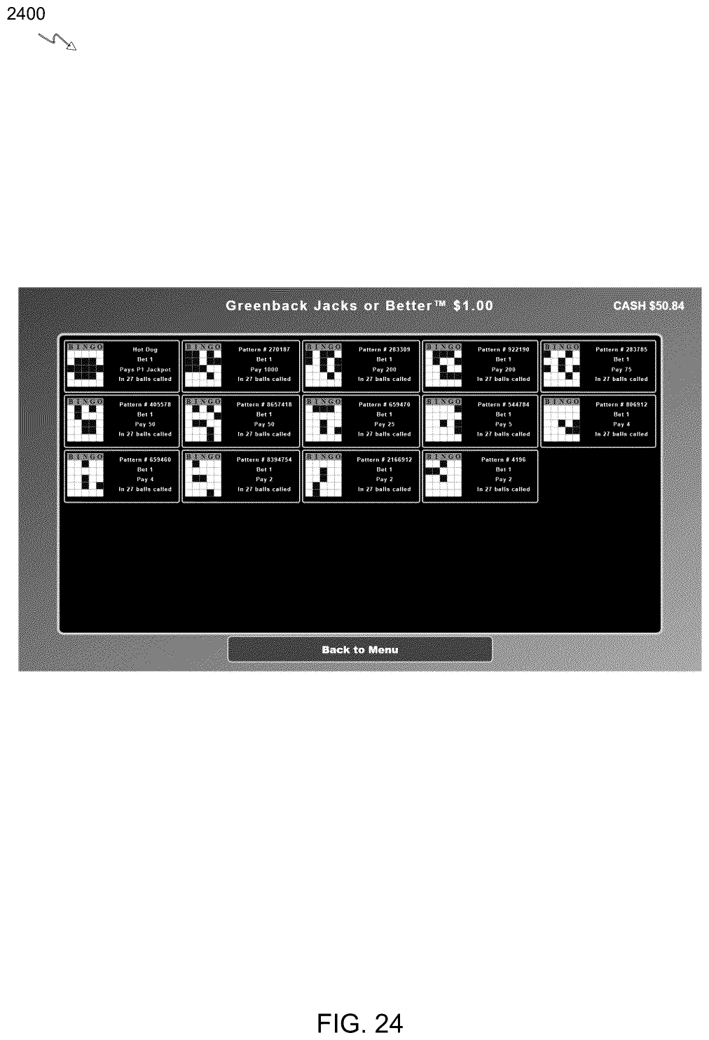

The side bet paytables may be organized by game theme and denomination, and are based on the configuration of the gaming device that is stored at bingo server 1506. For example, one possible configuration of side bet paytables is shown in FIG. 22. Selection of any of the options shown in FIG. 22 may cause display of the pattern information for that selected specific game theme and denomination (example pattern information is shown in FIGS. 23 and 24).

FIGS. 23 and 24 illustrate example screenshots and/or interfaces 2300, 2400 of example paytables for an electronic game including a side bet progressive, in accordance with the present disclosure. For instance, the paytable shown in FIG. 23 may be displayed after selection of side bet game selector 2202, shown in FIG. 22 (e.g., corresponding to the card side bet game at a 25-cent denomination), and the paytable shown in FIG. 24 may be displayed after selection of side bet game selector 2204, shown in FIG. 22 (e.g., corresponding to the card side bet game at a $1 denomination). Within each side bet paytable, there may be a specific pattern that causes the side bet progressive to be provided (e.g., and is displayed at the gaming device as such). For instance, the Hot Dog pattern in FIGS. 23 and 24 is displayed with “Pays P1 Jackpot” (e.g., the progressive side bet jackpot) descriptor.

The example paytables shown in FIGS. 23 and 24 may be hosted at a server and transmitted to gaming devices where side bet games are provided.

Notably, because the help pages and paytables are stored at a server, new paytables and/or different math for the side bet games may be implemented remotely (e.g., via a connection to gaming devices) as well as help pages associated therewith.

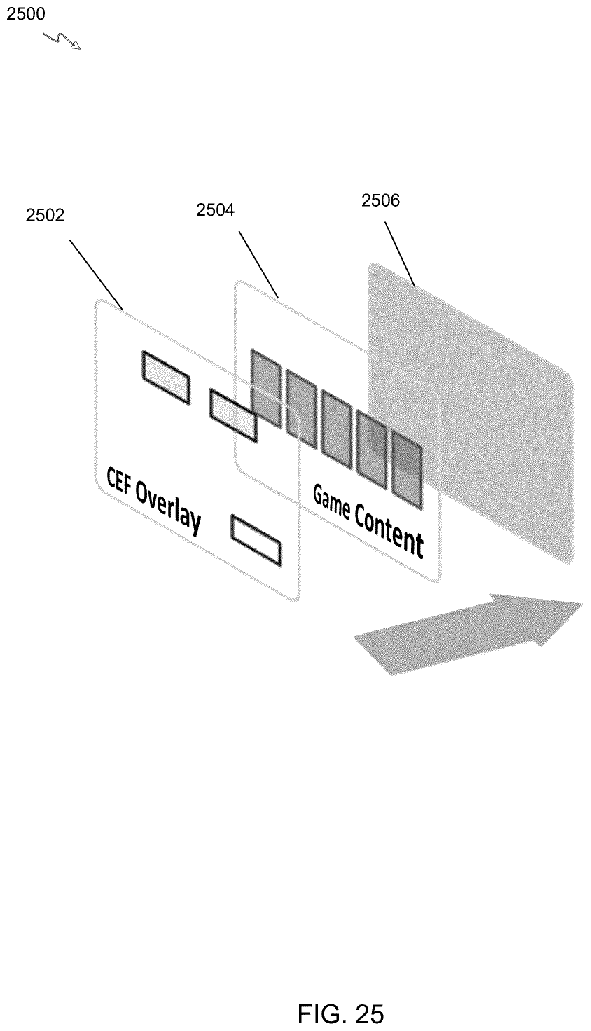

FIG. 25 illustrates a diagram 2500 of example content display layers for an electronic game including a side bet progressive, in accordance with the present disclosure.

The help content described herein may be written and/or stored at a server in HTML, CSS, and/or JavaScript. The help content may then be streamed to a gaming device from a web server built-in to the bingo server. To display this information to the player on the game screen at the gaming device, the content may be displayed using a custom web browser component named “CEF”, short for “Chromium Embedded Framework” (e.g., an industry standard library based on web browser technology).

CEF display content 2502 may be layered over the top of game content 2504 (e.g., reels, symbols, etc.) and/or a game background 2506, as shown in FIG. 25.

Using this layering approach, Class III games that use a Class III game engine can be converted to Class II games mostly as-is, with content specific to Class II Bingo (such as the help pages) displayed over the top of the game's content. This scheme allows Class III games to be ported to Class II without the requirement of modifying the game's core content. For help, the only requirement may be for the game code to be modified to ask CEF to display the HTML help pages rather than showing the game's normal (e.g., locally stored) help content from its built-in files (e.g., at the gaming device).

In an example embodiment, an electronic gaming system is described that includes at least one memory with instructions stored thereon and at least one processor in communication with the at least one memory. The instructions, when executed by the at least one processor, cause the at least one processor to receive game data from an electronic gaming device wherein the game data includes a game identifier (ID) associated with a game provided at the electronic gaming device. The instructions also cause the at least one processor to identify help data for the game provided at the electronic gaming device wherein the help data is identified based upon the game ID and from pluralities of help data associated with pluralities of game IDs and transmit the help data for the game to the electronic gaming device wherein the help data includes one or more help pages and one or more bingo patterns. The instructions further cause the at least one processor to receive input data from the electronic gaming device wherein the input data includes an input amount provided for a play of the game at the electronic gaming device and transmit output data to the electronic gaming device wherein the output data includes an output amount for the play of the game based upon at least one of the one or more bingo patterns transmitted in the help data.

Additional technical improvements provided by the present disclosure include the ability to generate and/or automatically update help pages (e.g., including paytables such as bingo patterns) for an electronic game, the ability to generate help pages at a server and stream and/or transmit data to an electronic gaming device that causes the help pages to be displayed based upon a configuration (e.g., available games, denominations, etc.) of the electronic gaming device, the ability to automatically generate (e.g., at a server) and/or provide (e.g., to an electronic gaming device) updated paytables including bingo patterns based upon a requested change in RTP, and the ability to provide help data for an electronic game as an overlay on game content (e.g., to allow Class III games to be efficiently converted to Class II games mostly as-is).

For example, based upon the help page and/or paytable generation at a server (e.g., a backend server), computer resources and computer efficiency are saved at electronic gaming devices in communication with the server because memory-intensive help pages and/or pay tables do not need to be stored at the electronic gaming devices. Further, because the paytables are stored at the server, computer efficiency of electronic gaming devices is improved because game outcomes (e.g., based upon analysis of a bingo card, ball call, and paytable including bingo patterns) are determined remotely at the server instead of locally at the electronic gaming devices.

Further, because the help pages can be generated, transmitted, and/or updated at the server, Class III games can easily be converted to Class II games because help pages can be provided remotely from the server (e.g., and updated as needed at the server) and the electronic gaming device can simply request an output from the server (e.g., based upon a configuration of the electronic gaming device and input data from the electronic gaming device) and provide and/or display game outcomes that correspond to the output received from the server. In other words, the electronic gaming device may act as a “thin client” that provides facades that correspond to the game outcomes without needing to generate the game outcomes themselves.

Additionally, technical security improvements are provided based upon the game outcomes and/or help pages being stored at the server. For instance, concerns regarding local tampering at the electronic gaming device are alleviated because paytables and help pages are stored at the server and game outcomes are generated at the server.

### Example Methods

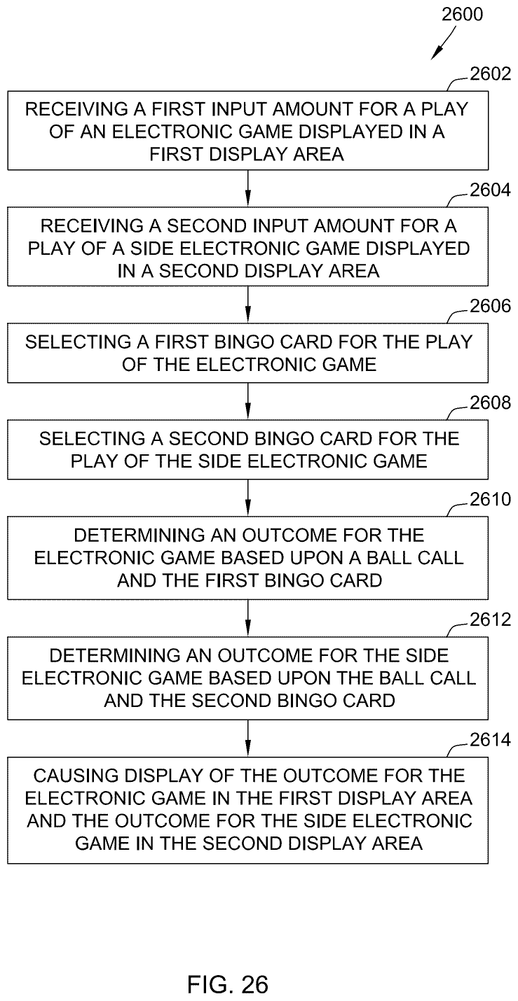

FIG. 26 illustrates an example method 2600 of electronic gaming including a side bet progressive, in accordance with the present disclosure. In an example embodiment, method 2600 includes receiving 2602 a first input amount for a play of an electronic game displayed in a first display area and receiving 2604 a second input amount for a play of a side electronic game displayed in a second display area wherein the first input amount is different from the second input amount. Method 2600 also includes selecting 2606 a first bingo card for the play of the electronic game and selecting 2608 a second bingo card for the play of the side electronic game. Method 2600 further includes determining 2610 an outcome for the electronic game based upon a ball call and the first bingo card, determining 2612 an outcome for the side electronic game based upon the ball call and the second bingo card, and causing 2614 display (e.g., concurrently) of the outcome for the electronic game in the first display area and the outcome for the side electronic game in the second display area.

In some embodiments, method 2600 further includes causing display of a side electronic game selector and, based upon selection of the side electronic game selector, at least one of enabling the side electronic game or disabling the side electronic game.

In some embodiments, method 2600 further includes causing display of a plurality of side electronic game selectors associated with a plurality of side electronic games and, based upon selection of one side electronic game selector of the plurality of side electronic game selectors, causing display of the one side electronic game selector as being illuminated and causing display of side electronic game selectors of the plurality of side electronic game selectors different from the one side electronic game as being darkened.

In some embodiments, method 2600 further includes determining that the outcome for the side electronic game includes a progressive jackpot associated with the side electronic game wherein the progressive jackpot is eligible to be provided based upon the side electronic game and is not eligible to be provided based upon the electronic game.

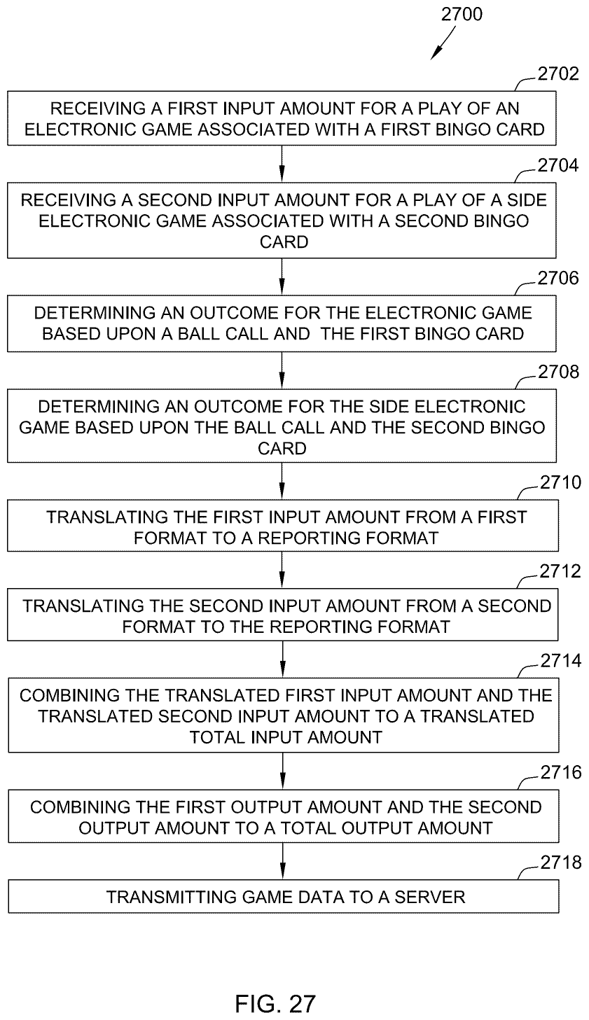

FIG. 27 illustrates an example method 2700 of electronic gaming including metering for a side bet progressive, in accordance with the present disclosure. In an example embodiment, method 2700 includes receiving 2702 a first input amount for a play of an electronic game associated with a first bingo card wherein the first input amount is associated with a first denomination and receiving 2704 a second input amount for a play of a side electronic game associated with a second bingo card wherein the first input amount is different from the second input amount and wherein the second input amount is associated with a second denomination. Method 2700 also includes determining 2706 an outcome for the electronic game based upon a ball call and the first bingo card wherein the outcome for the electronic game is associated with a first output amount and determining 2708 an outcome for the side electronic game based upon the ball call and the second bingo card wherein the outcome for the side electronic game is associated with a second output amount different from the first output amount. Method 2700 further includes translating 2710 the first input amount from a first format to a reporting format wherein the reporting format is associated with a reporting denomination that is different from the first denomination and the second denomination and translating 2712 the second input amount from a second format to the reporting format. Method 2700 also includes combining 2714 the translated first input amount and the translated second input amount to a translated total input amount, combining 2716 the first output amount and the second output amount to a total output amount, and transmitting 2718 game data to a server wherein the game data includes the translated total input amount in the reporting format and the total output amount.

In some aspects, method 2700 includes transmitting input data to a bingo server, the input data including the first input amount and the second input amount, and receiving output data from the bingo server wherein the output data is associated with the ball call.

In some aspects, method 2700 includes determining the outcome for the electronic game and the outcome for the side electronic game based upon one or more messages received from a bingo server.

In some aspects of method 2700, the reporting denomination is a one-cent denomination.

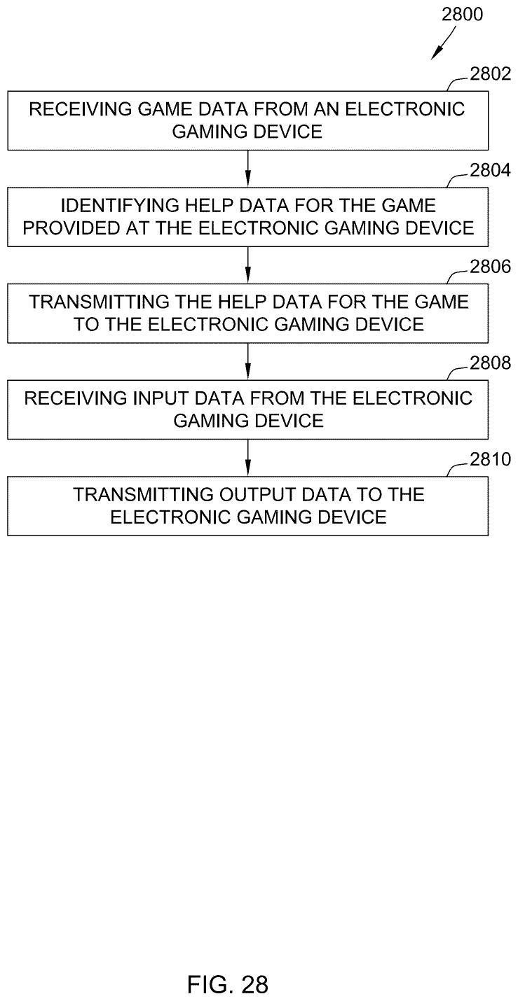

FIG. 28 illustrates an example method 2800 of electronic gaming including dynamically generated help pages, in accordance with the present disclosure. In an example embodiment, method 2800 includes receiving 2802 game data from an electronic gaming device, the game data including a game identifier (ID) associated with a game provided at the electronic gaming device, and identifying 2804 help data for the game provided at the electronic gaming device wherein the help data is identified based upon the game ID and from pluralities of help data associated with pluralities of game IDs. Method 2800 also includes transmitting 2806 the help data for the game to the electronic gaming device wherein the help data includes one or more help pages and one or more bingo patterns. Method 2800 further includes receiving 2808 input data from the electronic gaming device, the input data including an input amount provided for a play of the game at the electronic gaming device, and transmitting 2810 output data to the electronic gaming device, the output data including an output amount for the play of the game based upon at least one of the one or more bingo patterns transmitted in the help data.

In some aspects of method 2800, the game data further includes input option data, the input option data including input amounts that are available for selection at the electronic gaming device, wherein method 2800 further includes causing the at least one processor to identify the help data further based upon the input option data.

In some aspects of method 2800, the help data includes a plurality of paytables wherein the plurality of paytables include a plurality of bingo patterns.

In some aspects, method 2800 further includes determining the output amount for the play of the game based at least in part upon one or more bingo cards and one or more ball calls wherein the one or more bingo cards include a first bingo card for a base game and a second bingo card for a side game and wherein the input amount includes a first input amount for the base game and a second input amount for the side game.

### Example Aspects

In one aspect, an electronic gaming system including at least one memory with instructions stored thereon and at least one processor in communication with the at least one memory is described. The instructions, when executed by the at least one processor, cause the at least one processor to receive a first input amount for a play of an electronic game displayed in a first display area and receive a second input amount for a play of a side electronic game displayed in a second display area wherein the first input amount is different from the second input amount. The instructions also cause the at least one processor to select a first bingo card for the play of the electronic game and select a second bingo card for the play of the side electronic game. The instructions further cause the at least one processor to determine an outcome for the electronic game based upon a ball call and the first bingo card, determine an outcome for the side electronic game based upon the ball call and the second bingo card, and cause display of the outcome for the electronic game in the first display area and the outcome for the side electronic game in the second display area.

In some aspects, the instructions further cause the at least one processor to cause display of a side electronic game selector and, based upon selection of the side electronic game selector, at least one of enable the side electronic game or disable the side electronic game.

In some aspects, the instructions further cause the at least one processor to cause display of a plurality of side electronic game selectors associated with a plurality of side electronic games. In some aspects, the instructions further cause the at least one processor to, based upon selection of one side electronic game selector of the plurality of side electronic game selectors wherein the one side electronic game selector is associated with one side electronic game of the plurality of side electronic games, identify the one side electronic game as the side electronic game. In some aspects, the instructions further cause the at least one processor to, based upon selection of one side electronic game selector of the plurality of side electronic game selectors, cause display of the one side electronic game selector as being illuminated and cause display of side electronic game selectors of the plurality of side electronic game selectors different from the one side electronic game as being darkened.

In some aspects the instructions further cause the at least one processor to determine that the outcome for the side electronic game includes a progressive jackpot associated with the side electronic game wherein the progressive jackpot is eligible to be provided based upon the side electronic game and is not eligible to be provided based upon the electronic game.

In some aspects, the instructions further cause the at least one processor to, based upon a progressive jackpot being eligible to be provided, cause display of the second bingo card in a different format from display of bingo cards that are not eligible to cause the progressive jackpot to be provided. In some aspects, the instructions further cause the second bingo card to be displayed with an illumination adjacent to a border of the second bingo card wherein the different format includes the illumination.

In another aspect, at least one non-transitory computer readable storage medium with instructions stored thereon is described. The instructions, in response to execution by at least one processor, cause the at least one processor to receive a first input amount for a play of an electronic game displayed in a first display area and receive a second input amount for a play of a side electronic game displayed in a second display area wherein the first input amount is different from the second input amount. The instructions also cause the at least one processor to select a first bingo card for the play of the electronic game, select a second bingo card for the play of the side electronic game, and determine an outcome for the electronic game based upon a ball call and the first bingo card. The instructions further cause the at least one processor to determine an outcome for the side electronic game based upon the ball call and the second bingo card and cause display of the outcome for the electronic game in the first display area and the outcome for the side electronic game in the second display area.

In some aspects, the instructions further cause the at least one processor to cause display of a side electronic game selector and, based upon selection of the side electronic game selector, at least one of enable the side electronic game or disable the side electronic game.

In some aspects, the instructions further cause the at least one processor to cause display of a plurality of side electronic game selectors associated with a plurality of side electronic games. In some aspects, the instructions further cause the at least one processor to, based upon selection of one side electronic game selector of the plurality of side electronic game selectors wherein the one side electronic game selector is associated with one side electronic game of the plurality of side electronic games, identify the one side electronic game as the side electronic game. In some aspects, the instructions further cause the at least one processor to, based upon selection of one side electronic game selector of the plurality of side electronic game selectors, cause display of the one side electronic game selector as being illuminated and cause display of side electronic game selectors of the plurality of side electronic game selectors different from the one side electronic game as being darkened.

In some aspects, the instructions further cause the at least one processor to determine that the outcome for the side electronic game includes a progressive jackpot associated with the side electronic game wherein the progressive jackpot is eligible to be provided based upon the side electronic game and is not eligible to be provided based upon the electronic game.

In some aspects, the instructions further cause the at least one processor to, based upon a progressive jackpot being eligible to be provided, cause display of the second bingo card in a different format from display of bingo cards that are not eligible to cause the progressive jackpot to be provided. In some aspects, the instructions further cause the second bingo card to be displayed with an illumination adjacent to a border of the second bingo card wherein the different format includes the illumination.

In another aspect, a method of electronic gaming implemented by at least one processor in communication with at least one memory is described. The method includes receiving a first input amount for a play of an electronic game displayed in a first display area and receiving a second input amount for a play of a side electronic game displayed in a second display area wherein the first input amount is different from the second input amount. The method also includes selecting a first bingo card for the play of the electronic game and selecting a second bingo card for the play of the side electronic game. The method further includes determining an outcome for the electronic game based upon a ball call and the first bingo card, determining an outcome for the side electronic game based upon the ball call and the second bingo card, and causing display of the outcome for the electronic game in the first display area and the outcome for the side electronic game in the second display area.

In some aspects, the method further includes causing display of a side electronic game selector and, based upon selection of the side electronic game selector, at least one of enabling the side electronic game or disabling the side electronic game.

In some aspects, the method further includes causing display of a plurality of side electronic game selectors associated with a plurality of side electronic games and, based upon selection of one side electronic game selector of the plurality of side electronic game selectors, causing display of the one side electronic game selector as being illuminated and causing display of side electronic game selectors of the plurality of side electronic game selectors different from the one side electronic game as being darkened.

In some aspects, the method further includes determining that the outcome for the side electronic game includes a progressive jackpot associated with the side electronic game wherein the progressive jackpot is eligible to be provided based upon the side electronic game and is not eligible to be provided based upon the electronic game.

In another aspect, an electronic gaming system including at least one memory with instructions stored thereon and at least one processor in communication with the at least one memory is described. The instructions, when executed by the at least one processor, cause the at least one processor to receive a first input amount for a play of an electronic game associated with a first bingo card wherein the first input amount is associated with a first denomination and receive a second input amount for a play of a side electronic game associated with a second bingo card wherein the first input amount is different from the second input amount and wherein the second input amount is associated with a second denomination. The instructions also cause the at least one processor to determine an outcome for the electronic game based upon a ball call and the first bingo card wherein the outcome for the electronic game is associated with a first output amount and determine an outcome for the side electronic game based upon the ball call and the second bingo card wherein the outcome for the side electronic game is associated with a second output amount different from the first output amount. The instructions further cause the at least one processor to translate the first input amount from a first format to a reporting format wherein the reporting format is associated with a reporting denomination that is different from the first denomination and the second denomination and translate the second input amount from a second format to the reporting format. The instructions also cause the at least one processor to combine the translated first input amount and the translated second input amount to a translated total input amount, combine the first output amount and the second output amount to a total output amount, and transmit game data to a server wherein the game data includes the translated total input amount in the reporting format and the total output amount.

In some aspects, the instructions further cause the at least one processor to transmit input data to a bingo server, the input data including the first input amount and the second input amount. In some aspects, the instructions further cause the at least one processor to receive output data from the bingo server wherein the output data is associated with the ball call.

In some aspects, the instructions further cause the at least one processor to determine the outcome for the electronic game and the outcome for the side electronic game based upon one or more messages received from a bingo server.

In some aspects, the game data further includes at least one game identifier (ID) associated with one or more of the electronic game or the side electronic game.

In some aspects, the server is an accounting server that receives data from a plurality of electronic gaming devices.

In some aspects, the reporting denomination is a one-cent denomination.

In some aspects, the game data is transmitted as a single play of a game, the game including the play of the electronic game and the play of the side electronic game.

In another aspect, at least one non-transitory computer-readable storage medium with instructions stored thereon is described. The instructions, in response to execution by at least one processor, cause the at least one processor to receive a first input amount for a play of an electronic game associated with a first bingo card wherein the first input amount is associated with a first denomination and receive a second input amount for a play of a side electronic game associated with a second bingo card wherein the first input amount is different from the second input amount and wherein the second input amount is associated with a second denomination. The instructions also cause the at least one processor to determine an outcome for the electronic game based upon a ball call and the first bingo card wherein the outcome for the electronic game is associated with a first output amount and determine an outcome for the side electronic game based upon the ball call and the second bingo card wherein the outcome for the side electronic game is associated with a second output amount different from the first output amount. The instructions further cause the at least one processor to translate the first input amount from a first format to a reporting format wherein the reporting format is associated with a reporting denomination that is different from the first denomination and the second denomination and translate the second input amount from a second format to the reporting format. The instructions also cause the at least one processor to combine the translated first input amount and the translated second input amount to a translated total input amount, combine the first output amount and the second output amount to a total output amount, and transmit game data to a server wherein the game data includes the translated total input amount in the reporting format and the total output amount.

In some aspects, the instructions further cause the at least one processor to transmit input data to a bingo server, the input data including the first input amount and the second input amount. In some aspects, the instructions further cause the at least one processor to receive output data from the bingo server wherein the output data is associated with the ball call.

In some aspects, the instructions further cause the at least one processor to determine the outcome for the electronic game and the outcome for the side electronic game based upon one or more messages received from a bingo server.

In some aspects, the game data further includes at least one game identifier (ID) associated with one or more of the electronic game or the side electronic game.

In some aspects, the server is an accounting server that receives data from a plurality of electronic gaming devices.

In some aspects, the reporting denomination is a one-cent denomination.

In some aspects, the game data is transmitted as a single play of a game, the game including the play of the electronic game and the play of the side electronic game.

In another aspect, a method of metering in electronic gaming implemented by at least one processor in communication with at least one memory is described. The method includes receiving a first input amount for a play of an electronic game associated with a first bingo card wherein the first input amount is associated with a first denomination and receiving a second input amount for a play of a side electronic game associated with a second bingo card wherein the first input amount is different from the second input amount and wherein the second input amount is associated with a second denomination. The method also includes determining an outcome for the electronic game based upon a ball call and the first bingo card wherein the outcome for the electronic game is associated with a first output amount and determining an outcome for the side electronic game based upon the ball call and the second bingo card wherein the outcome for the side electronic game is associated with a second output amount different from the first output amount. The method further includes translating the first input amount from a first format to a reporting format wherein the reporting format is associated with a reporting denomination that is different from the first denomination and the second denomination and translating the second input amount from a second format to the reporting format. The method also includes combining the translated first input amount and the translated second input amount to a translated total input amount, combining the first output amount and the second output amount to a total output amount, and transmitting game data to a server wherein the game data includes the translated total input amount in the reporting format and the total output amount.

In some aspects, the method includes transmitting input data to a bingo server, the input data including the first input amount and the second input amount, and receiving output data from the bingo server wherein the output data is associated with the ball call.

In some aspects, the method includes determining the outcome for the electronic game and the outcome for the side electronic game based upon one or more messages received from a bingo server.

In some aspects, the reporting denomination is a one-cent denomination.

In another aspect, an electronic gaming system including at least one memory with instructions stored thereon and at least one processor in communication with the at least one memory is described. The instructions, when executed by the at least one processor, cause the at least one processor to receive game data from an electronic gaming device, the game data including a game identifier (ID) associated with a game provided at the electronic gaming device, and identify help data for the game provided at the electronic gaming device wherein the help data is identified based upon the game ID and from pluralities of help data associated with pluralities of game IDs. The instructions also cause the at least one processor to transmit the help data for the game to the electronic gaming device wherein the help data includes one or more help pages and one or more bingo patterns. The instructions further cause the at least one processor to receive input data from the electronic gaming device, the input data including an input amount provided for a play of the game at the electronic gaming device, and transmit output data to the electronic gaming device, the output data including an output amount for the play of the game based upon at least one of the one or more bingo patterns transmitted in the help data.

In some aspects, the game data further includes input option data, the input option data including input amounts that are available for selection at the electronic gaming device. In some aspects, the instructions further cause the at least one processor to identify the help data further based upon the input option data.

In some aspects, the help data includes a plurality of paytables. In some aspects, the plurality of paytables include a plurality of bingo patterns.

In some aspects, the instructions further cause the at least one processor to determine the output amount for the play of the game based at least in part upon one or more bingo cards and one or more ball calls. In some aspects, the one or more bingo cards include a first bingo card for a base game and a second bingo card for a side game. In some aspects, the input amount includes a first input amount for the base game and a second input amount for the side game.

In another aspect, at least one non-transitory computer-readable storage medium with instructions stored thereon is described. The instructions, in response to execution by at least one processor, cause the at least one processor to receive game data from an electronic gaming device, the game data including a game identifier (ID) associated with a game provided at the electronic gaming device, and identify help data for the game provided at the electronic gaming device wherein the help data is identified based upon the game ID and from pluralities of help data associated with pluralities of game IDs. The instructions also cause the at least one processor to transmit the help data for the game to the electronic gaming device wherein the help data includes one or more help pages and one or more bingo patterns. The instructions further cause the at least one processor to receive input data from the electronic gaming device, the input data including an input amount provided for a play of the game at the electronic gaming device, and transmit output data to the electronic gaming device, the output data including an output amount for the play of the game based upon at least one of the one or more bingo patterns transmitted in the help data.

In some aspects, the game data further includes input option data, the input option data including input amounts that are available for selection at the electronic gaming device. In some aspects, the instructions further cause the at least one processor to identify the help data further based upon the input option data.

In some aspects, the help data includes a plurality of paytables. In some aspects, the plurality of paytables include a plurality of bingo patterns.

In some aspects, the instructions further cause the at least one processor to determine the output amount for the play of the game based at least in part upon one or more bingo cards and one or more ball calls. In some aspects, the one or more bingo cards include a first bingo card for a base game and a second bingo card for a side game. In some aspects, the input amount includes a first input amount for the base game and a second input amount for the side game.

In another aspect, a method of electronic gaming implemented by at least one processor in communication with at least one memory is described. The method includes receiving game data from an electronic gaming device, the game data including a game identifier (ID) associated with a game provided at the electronic gaming device, and identifying help data for the game provided at the electronic gaming device wherein the help data is identified based upon the game ID and from pluralities of help data associated with pluralities of game IDs. The method also includes transmitting the help data for the game to the electronic gaming device wherein the help data includes one or more help pages and one or more bingo patterns. The method further includes receiving input data from the electronic gaming device, the input data including an input amount provided for a play of the game at the electronic gaming device, and transmitting output data to the electronic gaming device, the output data including an output amount for the play of the game based upon at least one of the one or more bingo patterns transmitted in the help data.

In some aspects, the game data further includes input option data, the input option data including input amounts that are available for selection at the electronic gaming device, wherein the method further includes causing the at least one processor to identify the help data further based upon the input option data.

In some aspects, the help data includes a plurality of paytables wherein the plurality of paytables include a plurality of bingo patterns.

In some aspects, the method further includes determining the output amount for the play of the game based at least in part upon one or more bingo cards and one or more ball calls wherein the one or more bingo cards include a first bingo card for a base game and a second bingo card for a side game and wherein the input amount includes a first input amount for the base game and a second input amount for the side game.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
at least one memory with instructions stored thereon; and
at least one processor in communication with the at least one memory, wherein the instructions, when executed by the at least one processor, cause the at least one processor to:
receive a first input amount for a play of an electronic game displayed in a first display area;
receive a second input amount for a play of a side electronic game displayed in a second display area, wherein the first input amount is different from the second input amount;
select a first bingo card for the play of the electronic game;
select a second bingo card for the play of the side electronic game;
determine an outcome for the electronic game based upon a ball call and the first bingo card;
determine an outcome for the side electronic game based upon the ball call and the second bingo card; and
cause display of the outcome for the electronic game in the first display area and the outcome for the side electronic game in the second display area.

2. The electronic gaming system of claim 1, wherein the instructions further cause the at least one processor to:
cause display of a side electronic game selector; and
based upon selection of the side electronic game selector, at least one of enable the side electronic game or disable the side electronic game.

3. The electronic gaming system of claim 1, wherein the instructions further cause the at least one processor to cause display of a plurality of side electronic game selectors associated with a plurality of side electronic games.

4. The electronic gaming system of claim 3, wherein the instructions further cause the at least one processor to, based upon selection of one side electronic game selector of the plurality of side electronic game selectors, wherein the one side electronic game selector is associated with one side electronic game of the plurality of side electronic games, identify the one side electronic game as the side electronic game.

5. The electronic gaming system of claim 3, wherein the instructions further cause the at least one processor to, based upon selection of one side electronic game selector of the plurality of side electronic game selectors:
cause display of the one side electronic game selector as being illuminated; and
cause display of side electronic game selectors of the plurality of side electronic game selectors different from the one side electronic game as being darkened.

6. The electronic gaming system of claim 1, wherein the instructions further cause the at least one processor to determine that the outcome for the side electronic game comprises a progressive jackpot associated with the side electronic game, wherein the progressive jackpot is eligible to be provided based upon the side electronic game and is not eligible to be provided based upon the electronic game.

7. The electronic gaming system of claim 1, wherein the instructions further cause the at least one processor to, based upon a progressive jackpot being eligible to be provided, cause display of the second bingo card in a different format from display of bingo cards that are not eligible to cause the progressive jackpot to be provided.

8. The electronic gaming system of claim 7, wherein the instructions further cause the second bingo card to be displayed with an illumination adjacent to a border of the second bingo card, wherein the different format comprises the illumination.

9. At least one non-transitory computer readable storage medium with instructions stored thereon that, in response to execution by at least one processor, cause the at least one processor to:
receive a first input amount for a play of an electronic game displayed in a first display area;
receive a second input amount for a play of a side electronic game displayed in a second display area, wherein the first input amount is different from the second input amount;
select a first bingo card for the play of the electronic game;
select a second bingo card for the play of the side electronic game;
determine an outcome for the electronic game based upon a ball call and the first bingo card;
determine an outcome for the side electronic game based upon the ball call and the second bingo card; and
cause display of the outcome for the electronic game in the first display area and the outcome for the side electronic game in the second display area.

10. The at least one non-transitory computer-readable storage medium of claim 9, wherein the instructions further cause the at least one processor to:
cause display of a side electronic game selector; and
based upon selection of the side electronic game selector, at least one of enable the side electronic game or disable the side electronic game.

11. The at least one non-transitory computer-readable storage medium of claim 9, wherein the instructions further cause the at least one processor to cause display of a plurality of side electronic game selectors associated with a plurality of side electronic games.

12. The at least one non-transitory computer-readable storage medium of claim 11, wherein the instructions further cause the at least one processor to, based upon selection of one side electronic game selector of the plurality of side electronic game selectors, wherein the one side electronic game selector is associated with one side electronic game of the plurality of side electronic games, identify the one side electronic game as the side electronic game.

13. The at least one non-transitory computer-readable storage medium of claim 11, wherein the instructions further cause the at least one processor to, based upon selection of one side electronic game selector of the plurality of side electronic game selectors:
cause display of the one side electronic game selector as being illuminated; and
cause display of side electronic game selectors of the plurality of side electronic game selectors different from the one side electronic game as being darkened.

14. The at least one non-transitory computer-readable storage medium of claim 9, wherein the instructions further cause the at least one processor to determine that the outcome for the side electronic game comprises a progressive jackpot associated with the side electronic game, wherein the progressive jackpot is eligible to be provided based upon the side electronic game and is not eligible to be provided based upon the electronic game.

15. The at least one non-transitory computer-readable storage medium of claim 9, wherein the instructions further cause the at least one processor to, based upon a progressive jackpot being eligible to be provided, cause display of the second bingo card in a different format from display of bingo cards that are not eligible to cause the progressive jackpot to be provided.

16. The at least one non-transitory computer-readable storage medium of claim 15, wherein the instructions further cause the second bingo card to be displayed with an illumination adjacent to a border of the second bingo card, wherein the different format comprises the illumination.

17. A method of electronic gaming implemented by at least one processor in communication with at least one memory, the method comprising:
receiving a first input amount for a play of an electronic game displayed in a first display area;
receiving a second input amount for a play of a side electronic game displayed in a second display area, wherein the first input amount is different from the second input amount;
selecting a first bingo card for the play of the electronic game;
selecting a second bingo card for the play of the side electronic game;
determining an outcome for the electronic game based upon a ball call and the first bingo card;
determining an outcome for the side electronic game based upon the ball call and the second bingo card; and
causing display of the outcome for the electronic game in the first display area and the outcome for the side electronic game in the second display area.

18. The method of claim 17, further comprising:
causing display of a side electronic game selector; and
based upon selection of the side electronic game selector, at least one of enabling the side electronic game or disabling the side electronic game.

19. The method of claim 17, further comprising:
causing display of a plurality of side electronic game selectors associated with a plurality of side electronic games; and
based upon selection of one side electronic game selector of the plurality of side electronic game selectors:
causing display of the one side electronic game selector as being illuminated; and
causing display of side electronic game selectors of the plurality of side electronic game selectors different from the one side electronic game as being darkened.

20. The method of claim 17, further comprising determining that the outcome for the side electronic game comprises a progressive jackpot associated with the side electronic game, wherein the progressive jackpot is eligible to be provided based upon the side electronic game and is not eligible to be provided based upon the electronic game.
